(19) United States
(12) Patent Application Publication
(10) Pub. No.: US 2025/0362952 A1
(43) Pub. Date: Nov. 27, 2025

(54) ICEBERG TABLE AUTO-REFRESH

(71) Applicant: Snowflake Inc., Bozeman, MT (US)

(72) Inventors: Abdullah Al Mahmood, Bothell, WA (US); Hao Dang, Redmond, WA (US); Ganeshan Ramachandran Iyer, Redmond, WA (US); Jonathan Lee Leang, Seattle, WA (US); Kevin Ye Jie Li, Burnaby (CA); Jiaxing Liang, Bellevue, WA (US); Raghav Ramachandran, Seattle, WA (US)

(21) Appl. No.: 18/670,489

(22) Filed: May 21, 2024

(51) Int. Cl. G06F 9/48; G06F 9/445

(52) U.S. Cl. CPC G06F 9/4881; G06F 9/44505; G06F 2209/486

(57) ABSTRACT

Provided herein are systems and methods for data table auto-refresh. An example method includes configuring a first processing pipeline definition comprising a first plurality of configurations associated with a corresponding plurality of notification fetching jobs for metadata of a database table. A second processing pipeline definition is configured to include a second plurality of configurations associated with the metadata. A source monitor pipeline is instantiated based on the first processing pipeline definition to fetch a manifest file based on the first plurality of configurations. A refresh pipeline is instantiated based on the second processing pipeline definition to perform a refresh operation of the metadata and generate refreshed metadata based on the second plurality of configurations.

### TECHNICAL FIELD

Embodiments of the disclosure generally relate to file processing in data platforms and, more specifically, to techniques for configuring discrete workload processing, such as performing auto-refresh for database tables (e.g., Iceberg tables).

### BACKGROUND

Databases are widely used for data storage and access in computing applications. A goal of database storage is to provide enormous sums of information in an organized manner so that it can be accessed, managed, updated, and shared. Data may be organized into rows, columns, and tables in a database. Different database storage systems may be used to store different types of content, such as bibliographic, full text, numeric, and image content. Further, in computing, different database systems may be classified according to the organizational approach of the database. There are many different types of databases, including relational, distributed, cloud, object-oriented, and others.

Databases may include one or more tables that include or reference data that can be joined, read, modified, or deleted using queries. Databases can store small or large sets of data within one or more tables. This data can be accessed by various users in an organization or even be used to service public users, such as via a website or an application programming interface (API). Both computing and storage resources and their underlying architecture can play a significant role in achieving desirable database performance, including facilitating access to different types of data. However, data processing, including the processing of files, can be associated with inefficient workload distribution, high latency, and inefficient allocation of compute resources.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based database system in communication with a cloud storage platform, in accordance with some embodiments of the present disclosure.

FIG. 2 is a block diagram illustrating the components of a compute service manager including a file processing manager (FPM), in accordance with some embodiments of the present disclosure.

FIG. 3 is a block diagram illustrating components of an execution platform with execution nodes configured to execute file processing jobs (e.g., for Iceberg table auto-refresh) and a source monitor, in accordance with some embodiments of the present disclosure.

FIG. 4 is a block diagram of a file processing service, in accordance with some embodiments of the present disclosure.

FIG. 5 is a block diagram illustrating an Iceberg metadata registration process, in accordance with some embodiments of the present disclosure.

FIG. 6 is a block diagram illustrating files defining an Iceberg table, which can be used in connection with the present disclosure.

FIG. 7 is a block diagram of a system for configuring a processing pipeline definition (PPD) used by a file processing service, in accordance with some embodiments of the present disclosure.

FIG. 8 is a block diagram of a source monitor definition instance associated with a PPD in a file processing service, in accordance with some embodiments of the present disclosure.

FIG. 9 is a diagram of a source monitor kind data structure that maps to a source monitor definition, in accordance with some embodiments of the present disclosure.

FIG. 10 is a diagram of a source monitor configuration, in accordance with some embodiments of the present disclosure.

FIG. 11 is a diagram of processing steps and corresponding query plan nodes performed by a refresh pipeline, in accordance with some embodiments of the present disclosure.

FIG. 12 is a table illustrating the evolvement of a work item during the processing steps performed in the refresh pipeline, in accordance with some embodiments of the present disclosure.

FIG. 13 is a block diagram of an Iceberg table auto-refresh architecture, in accordance with some embodiments of the present disclosure.

FIG. 14 is a block diagram of an implementation outline of an Iceberg table auto-refresh, in accordance with some embodiments of the present disclosure.

FIG. 15 is a table illustrating configurations for bootstrap refresh with auto-refresh, which can be used with disclosed techniques, in accordance with some embodiments of the present disclosure.

FIG. 16 is a diagram of an auto-refresh timeline where catalog polls lead to differently scaled workloads, in accordance with some embodiments of the present disclosure.

FIG. 17 is a flow diagram of a logical flow for coordinating an auto-refresh and a manual refresh when refreshes are requested while ongoing refreshes are still executing, in accordance with some embodiments of the present disclosure.

FIG. 18 is a diagram of a data branching example of divergent branches in Iceberg, in accordance with some embodiments of the present disclosure.

FIG. 19 is a diagram of a branch tracking example, in accordance with some embodiments of the present disclosure.

FIG. 20 is a diagram of lock acquisition and release timelines of a manual refresh for three snapshots of an Iceberg table, in accordance with some embodiments of the present disclosure.

FIG. 21 is a diagram of lock acquisition and release timelines of an auto-refresh for three snapshots of an Iceberg table, in accordance with some embodiments of the present disclosure.

FIG. 22 is a diagram of an Iceberg snapshot branching example, in accordance with some embodiments of the present disclosure.

FIG. 23 is a diagram of an accepted interrupter example where the interrupt is processed, and the downstream queue is flushed in an Iceberg table, in accordance with some embodiments of the present disclosure.

FIG. 24 is a diagram of an attempting interrupter example where the interrupt is prevented, and force queueing is performed to retain order in an Iceberg table, in accordance with some embodiments of the present disclosure.

FIG. 25 is a diagram of a logical flow for handling errors when polling the catalog and processing refresh operations for an Iceberg table, in accordance with some embodiments of the present disclosure.

FIG. 26 is a diagram of a system for processing an Iceberg table using a source monitor definition instance, in accordance with some embodiments of the present disclosure.

FIG. 27 is a block diagram of processing data by multiple PPD instances associated with different processing pipeline types, in accordance with some embodiments of the present disclosure.

FIG. 28 is a block diagram of a PPD used to process Apache Iceberg data, in accordance with some embodiments of the present disclosure.

FIG. 29 is a flow diagram illustrating the operations of a database system in performing a method for a database table auto-refresh, in accordance with some embodiments of the present disclosure.

FIG. 30 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

In the present disclosure, physical units of data that are stored in a data platform—and that make up the content of, e.g., database tables in customer accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and the like. If stored internally in the data platform, a given file is referred to herein as an “internal file” and may be stored in (or at, or on, etc.) what is referred to herein as an “internal storage location.” If stored external to the data platform, a given file is referred to herein as an “external file” and is referred to as being stored in (or at, or on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, extensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other examples of unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

As used herein, the term “processing pipe” (or “pipe”) indicates a functionality to support continuous processing of an abstract discrete item (e.g., an offset in a KAFKA topic, a step in a multi-step workflow, or any other unit of work that can be processed independently and can be considered a discrete item). In some aspects, the term “processing pipe” (or “pipe”) indicates a file processing service that can be used to ingest data and configure the processing of one or more tasks associated with the data. As used herein, the term “slot” indicates a compute resource unit for a compute node (e.g., a processor core or another compute resource).

As used herein, the term “slot” indicates a compute resource unit for a compute node (e.g., a processor core or another compute resource).

As used herein, the term “Iceberg table” refers to a database table in the Apache® Iceberg open-source data format.

The disclosed techniques can be used to configure (e.g., by a file processing manager or FPM) auto-refresh for unmanaged data tables (e.g., unmanaged Iceberg tables with Iceberg metadata sources). For example, the FPM can configure a first processing pipeline (e.g., a source monitor, also referred to as a source monitor pipeline) and a second processing pipeline (e.g., a refresh pipeline). The FPM can configure the source monitor pipeline as a continuous file processing service that retrieves metadata of a database table (e.g., an Iceberg table). In some aspects, the disclosed source monitor pipeline can be configured using a source monitor configuration based on a source monitor type that maps to a source monitor definition, scheduling information, and integration information. More specifically, a source monitor definition instance associated with a processing pipeline (e.g., defined by a processing pipeline definition) can be instantiated using the source monitor configuration. The source monitor definition instance can be configured to periodically poll a data source (e.g., a data source associated with the processing pipeline) and fetch one or more data elements that map to notifications (e.g., new or updated data available at the data source). The source monitor definition instance can filter the notifications and determine whether to forward the notifications to one or more work item queues of the processing pipeline and/or one or more additional work item queues of the same or different processing pipeline. In some aspects, the source monitor type can be referred to as a source monitor data structure kind.

In some aspects, the FPM can also configure a processing pipeline definition (PPD), which can be used to auto-refresh the database table in the refresh pipeline based on the metadata retrieved by the source monitor pipeline. In some aspects, the FPM can configure the PPD to include multiple processing configurations (or processing steps) to perform the auto-refresh. More specifically, the FPM can configure a pipeline definition service as part of the continuous file processing service. The pipeline definition service can discover and retrieve a manifest file and detect metadata for at least one workload specified by the manifest file. The pipeline definition service can generate a query plan for at least one workload and estimate the number of processing tasks (or jobs) that have to be executed by a compute node to complete at least one workload. A processing configuration (or a step) is generated and can specify the processing tasks (or jobs). In some aspects, the processing configuration can also specify the slots of at least one compute node that can be used to execute the processing tasks. The PPD can be generated as a collection of the configured processing steps. The PPD can be registered and subsequently used to monitor a data source and automatically instantiate a PPD instance (e.g., a processing pipeline) to process any detected data using the processing steps of the PPD.

The present disclosure discloses processing based on manifest files and manifest lists, which are concepts specific to Apache Iceberg tables. Even though metadata can be detected based on a manifest file or a manifest list, the disclosure is not limited in this regard and other types of files can be used to convey metadata (e.g., workload metadata) associated with table auto-refresh functionalities.

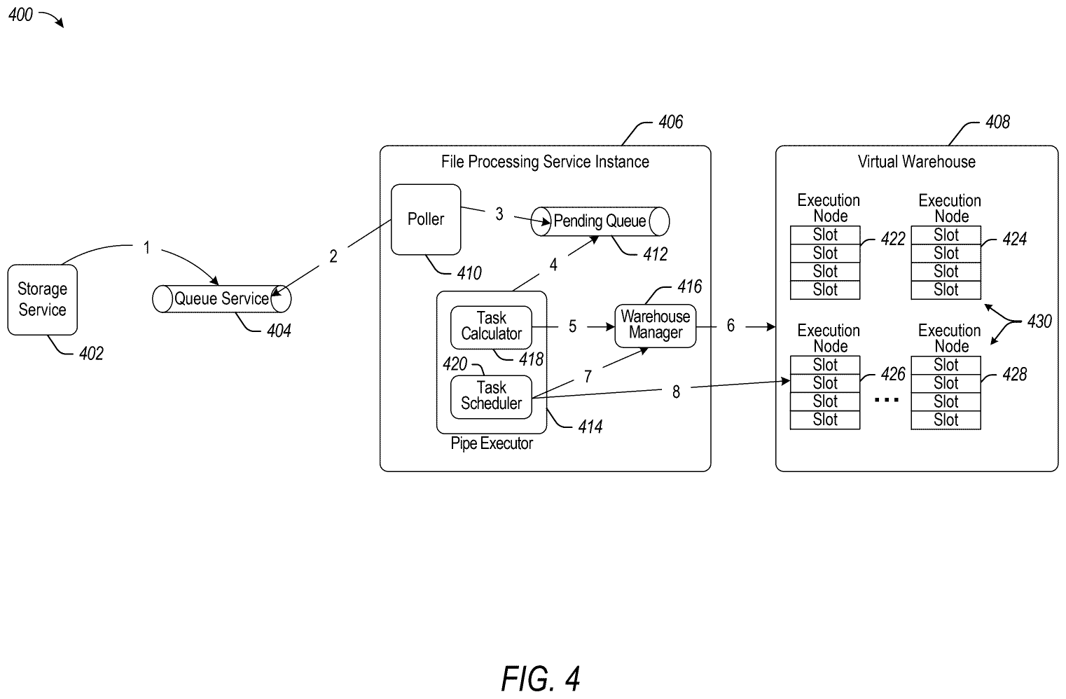

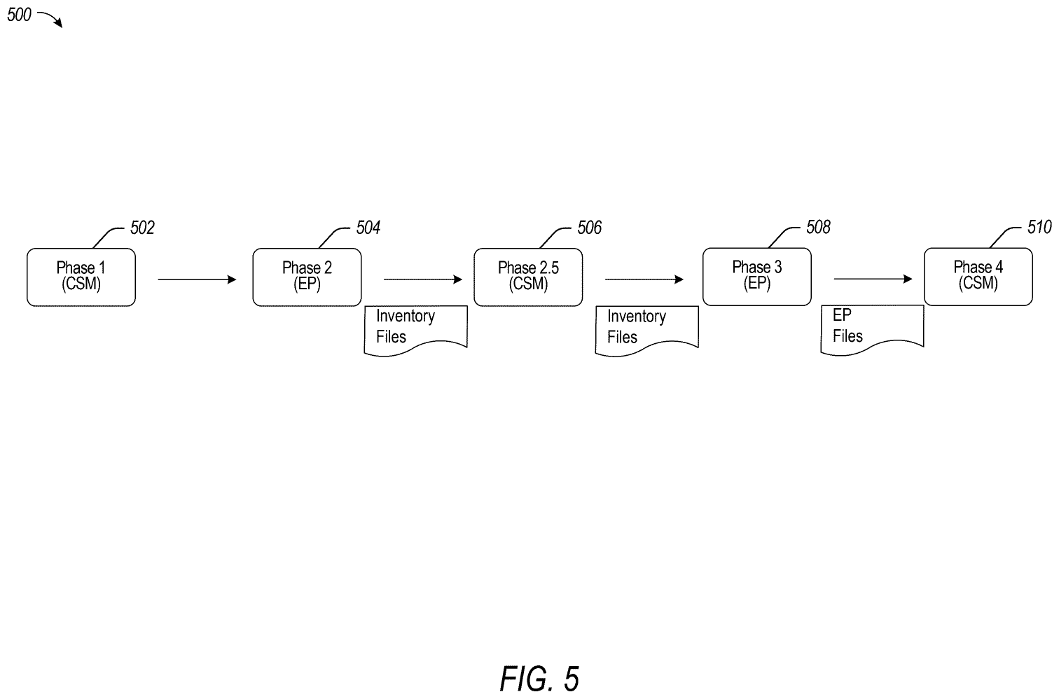

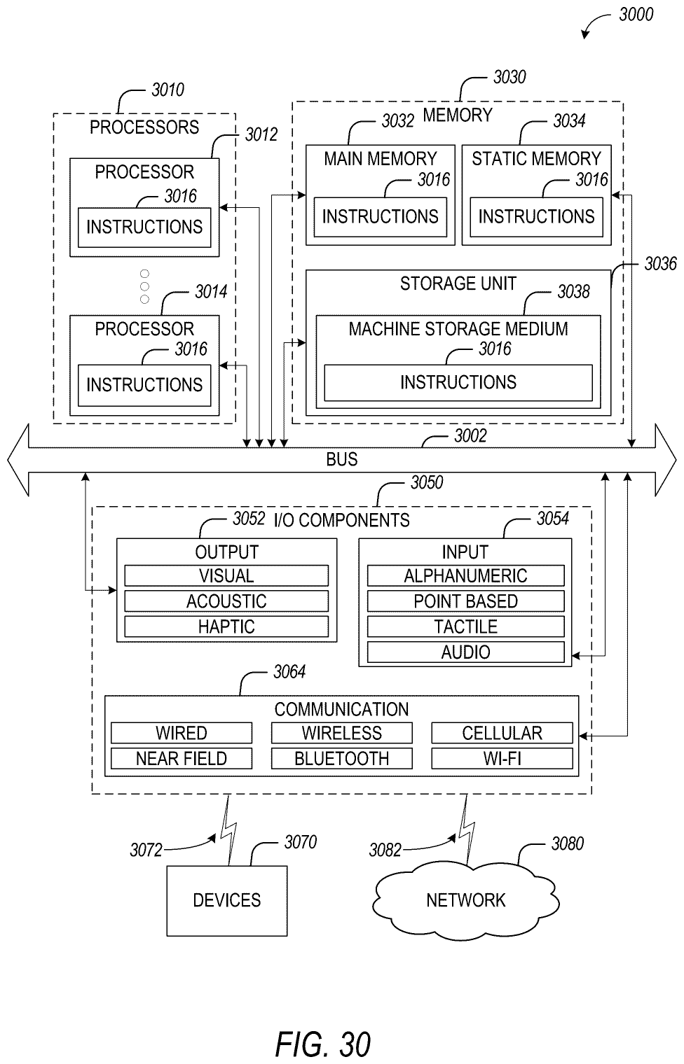

An additional description of the FPM and the configuration of the source monitor pipeline and the refresh pipeline in connection with a database table auto-refresh is provided in connection with FIG. 4-FIG. 29. Example PPDs for configuring a source monitor pipeline are discussed in connection with FIGS. 5, 7-10, 12-14, 26, and 27. Example PPDs for configuring a refresh pipeline are discussed in connection with FIGS. 5, 7, 8, 11-14, 27, and 28. A more detailed discussion of example computing devices that may be used in connection with the disclosed techniques is provided in connection with FIG. 30.

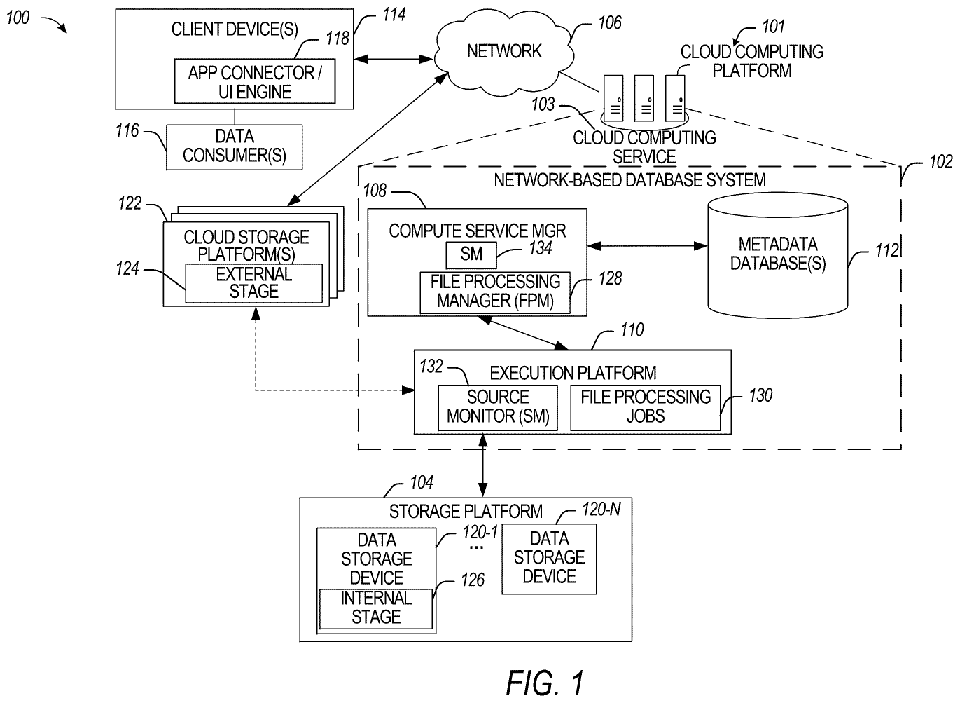

FIG. 1 illustrates an example computing environment 100 that includes a database system in the example form of a network-based database system 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not explicitly described herein. In other embodiments, the computing environment may comprise another type of network-based database system or a cloud data platform. For example, in some aspects, the computing environment 100 may include a cloud computing platform 101 with the network-based database system 102, storage platforms 104, and cloud storage platforms 122. The cloud computing platform 101 provides computing resources and storage resources that may be acquired (purchased) or leased (e.g., by data providers and data consumers) and configured to execute applications and store data.

The cloud computing platform 101 may host a cloud computing service 103 that facilitates storage of data on the cloud computing platform 101 (e.g., data management and access) and analysis functions (e.g., SQL queries, analysis), as well as other processing capabilities (e.g., performing the hash-join broadcast decision making functions described herein). The cloud computing platform 101 may include a three-tier architecture: data storage (e.g., storage platforms 104 and 122), an execution platform 110, and a compute service manager 108 providing cloud services. In some embodiments, the execution platform 110 is configured to provide services (e.g., executing file processing jobs 130 of a refresh pipeline configured by a PPD or a source monitor 132 configured based on a source monitor configuration) associated with the database table auto-refresh configured by the FPM 128. The auto-refresh processing can be based on the FPM generating at least one source monitor definition instance for a source monitor pipeline and a PPD instance for a refresh pipeline.

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and files of one or more other types—on, as examples, one or more of their servers and on one or more cloud-storage platforms such as AMAZON WEB SERVICES™ (AWS™), MICROSOFT® AZURE®, GOOGLE CLOUD PLATFORM™, and the like. The customer's servers and cloud-storage platforms are both examples of what a given customer could use as what is referred to herein as an external storage location. The cloud computing platform 101 could also use a cloud-storage platform, which is referred to herein as an internal storage location concerning the data platform.

From the perspective of the network-based database system 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and where external stages are stages that correspond to data storage at one or more external storage locations. In this regard, external files can be stored in external stages at one or more external storage locations. Internal files can be stored in internal stages at one or more internal storage locations, which can include servers managed and controlled by the same organization (e.g., company) that manages and controls the data platform, and which can instead or in addition include data storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 102 of the cloud computing platform 101 is in communication with the cloud storage platforms 104 and 122 (e.g., AWS®, Microsoft Azure Blob Storage®, or Google Cloud Storage), client device 114 (e.g., a data provider), and data consumer 116 via network 106. The network-based database system 102 is a network-based system used for reporting and analysis of integrated data from one or more disparate sources, including one or more storage locations within the cloud storage platform 104. The storage platform 104 comprises a plurality of computing machines and provides on-demand computer system resources such as data storage and computing power to the network-based database system 102.

The network-based database system 102 comprises a compute service manager 108, an execution platform 110, and one or more metadata databases 112. The network-based database system 102 hosts and provides data reporting and analysis services (as well as additional services such as the disclosed hash-join broadcast decision making functions) to multiple client accounts, including an account of the data provider associated with client device 114 and an account of the data consumer 116. In some embodiments, the execution platform 110 is configured to perform file processing jobs 130, which can be based on PPDs configured using the disclosed techniques. The execution platform 110 can also implement a source monitor 132 (e.g., based on instantiating at least one source monitor definition instance at an execution node) used in connection with a database table auto-refresh. In some aspects, FPM 128 can configure a source monitor 134 at the compute service manager 108 (e.g., based on instantiating at least one source monitor definition instance at the compute service manager 108), which can be used in connection with database table auto-refresh. A more detailed description of the file processing service functionalities of the FPM 128, including configuring a database table auto-refresh using a source monitor pipeline and a refresh pipeline is provided in connection with, e.g., FIGS. 4-29.

The compute service manager 108 coordinates and manages operations of the network-based database system 102. The compute service manager 108 also performs query optimization and compilation and manages clusters of computing services that provide computing resources (also referred to as “virtual warehouses”). The compute service manager 108 can support any number of client accounts, such as end-users providing data storage and retrieval requests, accounts of data providers, accounts of data consumers, system administrators managing the systems and methods described herein, and other components/devices that interact with the compute service manager 108.

The compute service manager 108 is also in communication with a client device 114. The client device 114 corresponds to a user of one of the multiple client accounts (e.g., a data provider) supported by the network-based database system 102. The data provider may utilize application connector 118 at the client device 114 to submit data storage, retrieval, and analysis requests to the compute service manager 108 as well as to access or configure other services provided by the compute service manager 108 (e.g., services associated with the disclosed file processing service functionalities such as providing one or more configurations used for a source monitor definition instance).

Client device 114 (also referred to as user device 114) may include one or more of a laptop computer, a desktop computer, a mobile phone (e.g., a smartphone), a tablet computer, a cloud-hosted computer, cloud-hosted serverless processes, or other computing processes or devices may be used to access services provided by the cloud computing platform 101 (e.g., cloud computing service 103) by way of a network 106, such as the Internet or a private network.

In the description below, actions are ascribed to users, particularly consumers and providers. Such actions shall be understood to be performed concerning client device (or devices) 114 operated by such users. For example, a notification to a user may be understood to be a notification transmitted to the client device 114, input or instruction from a user may be understood to be received by way of the client device 114, and interaction with an interface by a user shall be understood to be interaction with the interface on the client device 114. In addition, database operations (joining, aggregating, analysis, etc.) ascribed to a user (consumer or provider) shall be understood to include performing such actions by the cloud computing service 103 in response to an instruction from that user.

In some aspects, a data consumer 116 can communicate with the client device 114 to access functions offered by the data provider (e.g., file processing service functionalities, including auto-refresh functionalities). Additionally, the data consumer can access functions offered by the network-based database system 102 via network 106.

The compute service manager 108 is also coupled to one or more metadata databases 112 that store metadata about various functions and aspects associated with the network-based database system 102 and its users. For example, a metadata database 112 may include a summary of data stored in remote data storage systems as well as data available from a local cache. Additionally, a metadata database 112 may include information regarding how data is organized in remote data storage systems (e.g., the cloud storage platform 104) and the local caches. Information stored by a metadata database 112 allows systems and services to determine whether a piece of data needs to be accessed without loading or accessing the actual data from a storage device.

The compute service manager 108 is further coupled to the execution platform 110, which provides multiple computing resources (e.g., execution nodes) that execute, for example, various data storage, data retrieval, and data processing tasks. The execution platform 110 is coupled to storage platform 104 and cloud storage platforms 122. The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data storage technology. Additionally, the cloud storage platform 104 may include distributed file systems (such as Hadoop Distributed File Systems (HDFS)), object storage systems, and the like. In some embodiments, at least one internal stage 126 may reside on one or more of the data storage devices 120-1-120-N, and at least one external stage 124 may reside on one or more of the cloud storage platforms 122.

In some embodiments, communication links between elements of the computing environment 100 are implemented via one or more data communication networks, such as network 106. The one or more data communication networks may utilize any communication protocol and any communication medium. In some embodiments, the data communication networks are a combination of two or more data communication networks (or sub-networks) coupled with one another. In alternate embodiments, these communication links are implemented using any communication medium and any communication protocol.

The compute service manager 108, metadata database 112, execution platform 110, and storage platform 104 are shown in FIG. 1 as individual discrete components. However, each of the compute service manager 108, metadata database 112, execution platform 110, and storage platforms 104 and 122 may be implemented as a distributed system (e.g., distributed across multiple systems/platforms at multiple geographic locations). Additionally, each of the compute service manager 108, metadata database(s) 112, execution platform 110, and storage platforms 104 and 122 can be scaled up or down (independently of one another) depending on changes to the requests received and the changing needs of the network-based database system 102. Thus, in the described embodiments, the network-based database system 102 is dynamic and supports regular changes to meet the current data processing needs.

During typical operations, the network-based database system 102 processes multiple jobs as determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from and store data to any of the data storage resources in the cloud storage platform 104.

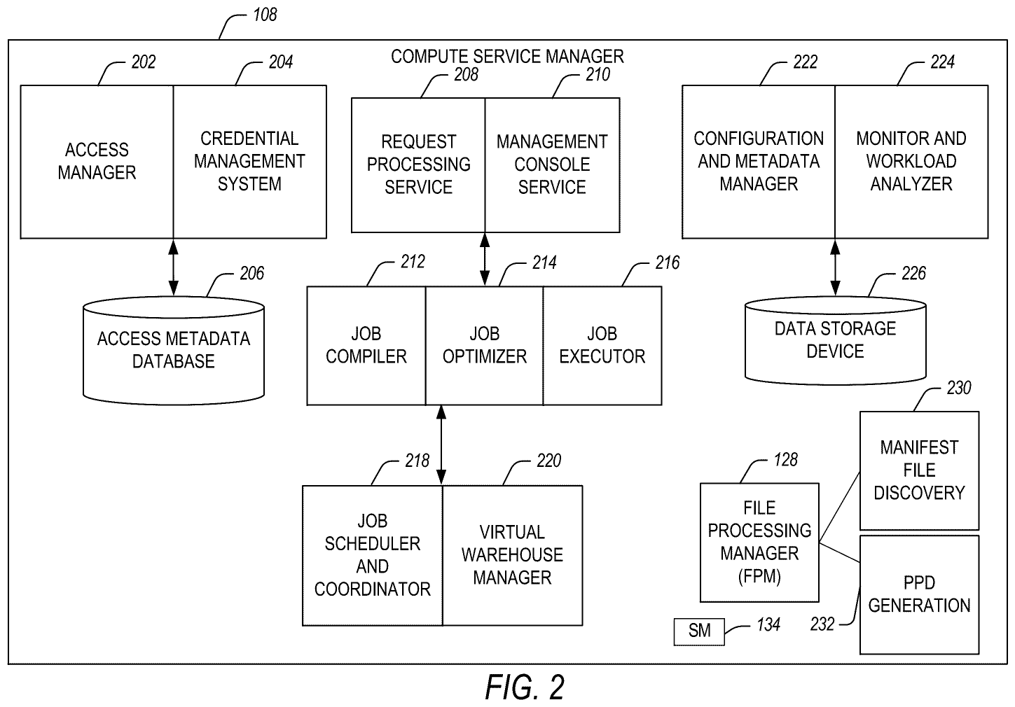

FIG. 2 is a block diagram illustrating the components of the compute service manager 108 including the FPM 128, in accordance with some embodiments of the present disclosure. As shown in FIG. 2, the compute service manager 108 includes an access manager 202 and a credential management system 204 coupled to an access metadata database 206, which is an example of the metadata database(s) 112. Access manager 202 handles authentication and authorization tasks for the systems described herein. The credential management system 204 facilitates the use of remotely stored credentials to access external resources, such as data resources in a remote storage device. As used herein, the remote storage devices may also be referred to as “persistent storage devices” or “shared storage devices.” For example, the credential management system 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in storage platform 104.

A management console service 210 supports administrators and other system managers' access to various systems and processes. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes a configuration and metadata manager 222, which manages the information related to the data stored in the remote data storage devices and the local buffers (e.g., the buffers in the execution platform 110). The configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based database system 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based database system 102. For example, data storage device 226 may represent buffers in execution platform 110, storage devices in storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing query A should not be allowed to request access to data source D (e.g., data storage device 226) that is not relevant to query A. Similarly, a given execution node (e.g., execution node 302-1 may need to communicate with another execution node (e.g., execution node 302-2) and should be disallowed from communicating with a third execution node (e.g., execution node 312-1) and any such illicit communication can be recorded (e.g., in a log or other location). Also, the information stored on a given execution node is restricted to data relevant to the current query, and any other data is unusable, rendered so by destruction or encryption where the key is unavailable.

In some aspects, compute service manager 108 includes the FPM 128. The FPM 128 is configured to perform disclosed techniques in connection with a database table auto-refresh using a source monitor pipeline and a refresh pipeline configured by corresponding PPDs. For example, FPM 128 can configure a source monitor pipeline to perform metadata discovery 230. FPM 128 can also perform PPD generation 232 (e.g., to generate PPDs used for configuring the source monitor pipeline and the refresh pipeline).

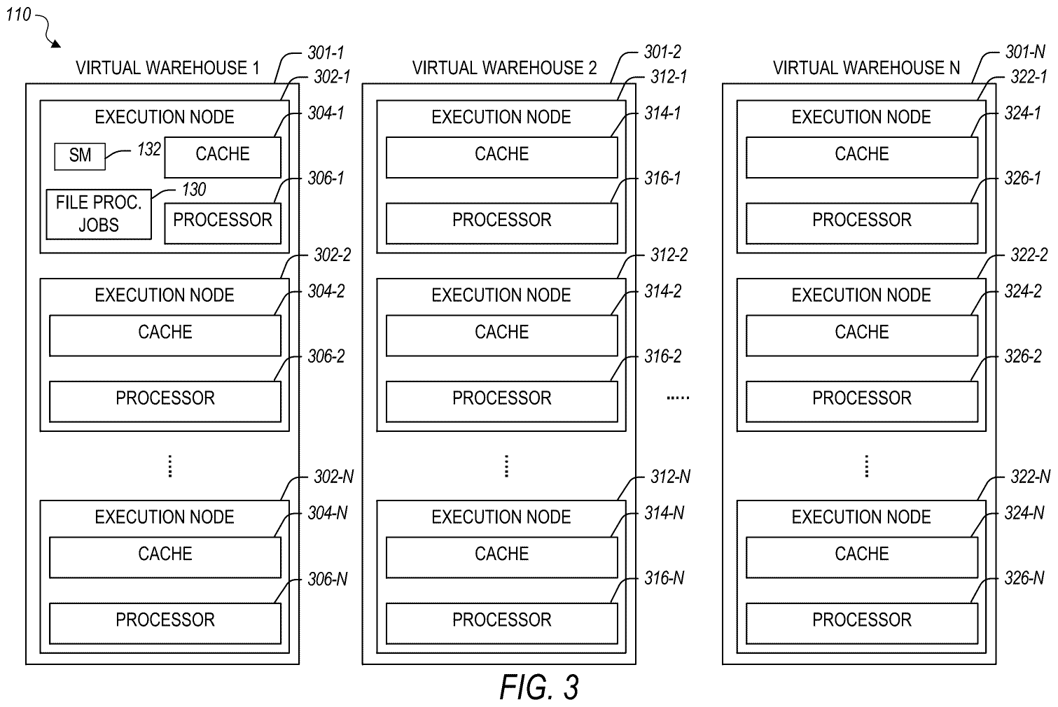

FIG. 3 is a block diagram illustrating components of an execution platform 110 with execution nodes configured to execute file processing jobs and a source monitor, in accordance with some embodiments of the present disclosure. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, they can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device. Still, the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes: 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes: 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the cloud storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes. This is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, which is helpful for tasks that require fast scanning of large amounts of data. In some embodiments, the cache resources and computing resources associated with a particular execution node are determined when the execution node is created based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, virtual warehouses 1, . . . , and N may be implemented using multiple computing systems at multiple geographic locations. For example, virtual warehouse 1 can be implemented by a computing system at a first geographic location, while another computing system implements virtual warehouses 2 and n at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, it is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and caching resources are needed. Similarly, existing virtual warehouses may be deleted when the resources associated with them are no longer necessary.

In some embodiments, the virtual warehouses may operate on the same data in the cloud storage platform 104. Still, each virtual warehouse has its execution nodes with independent processing and caching resources. This configuration allows requests on different virtual warehouses to be processed independently and with no interference between the requests. This independent processing, combined with the ability to add and remove virtual warehouses dynamically, supports the addition of new processing capacity for new users without impacting the performance observed by the existing users.

In some aspects, FPM 128 can configure one or more of the functionalities discussed in connection with FIG. 4-FIG. 29. For example, FPM 128 can configure a plugin or API that can be used to access the disclosed auto-refresh functionalities, including automating onboarding of new workloads, enabling configuration of PPDs, enabling configurations of source monitors (e.g., one or more source monitor configurations), enabling configurations of refresh pipelines, automating the execution of processing steps configured by PPDs (including automatic sequential or parallel execution of processing steps), and enabling workloads to be self-sufficient for operations (e.g., monitoring and alerting).

FIG. 4 is a block diagram of a file processing service 400, in accordance with some embodiments of the present disclosure. Referring to FIG. 4, the file processing service 400 includes a storage service 402 (e.g., Amazon S3), a queue service 404 (e.g., Amazon SQS), a file processing service instance 406, and a virtual warehouse 408.

In some aspects, the file processing service instance 406 can be configured as part of the compute service manager 108 and can include a poller 410, a pending queue 412, a pipe executor 414, and a warehouse manager. The pipe executor includes a task calculator 418 and a task scheduler 420.

In some aspects, the virtual warehouse 408 can be any of the virtual warehouses of the execution platform 110 (e.g., as illustrated in FIG. 3). Virtual warehouse 408 can include execution nodes 422, 424, 426, . . . , 428. Each of the execution nodes can be configured with a plurality of slots 430 (e.g., processing cores or other compute resources that can be allocated to individual tasks or processing jobs).

In operation, the storage service 402 sends event notifications for file creation. Poller 410 polls the queue service 404 for new event notifications. Poller 410 then forwards valid notifications to the pending queue 412. The pipe executor 414 can review the pending queue 412 and estimate (e.g., using the task calculator 418) a task count associated with one or more workloads stored as files in the pending queue 412. The estimated task count is sent to the warehouse manager 416. The warehouse manager 416 estimates the warehouse size of a virtual warehouse needed to execute the detected tasks (e.g., the estimation can be based on the task count). Virtual warehouse 408 is selected based on the task count. The task scheduler 420 fetches available slots (of execution nodes in the virtual warehouse 408) from the warehouse manager to schedule tasks and schedule the ingestion of the tasks on the available slots.

In some aspects, poller 410 can be configured as part of a source monitor pipeline based on the disclosed techniques. In some aspects, the functionalities of the pipe executor 414 can be configured as part of the disclosed source monitor pipeline and the refresh pipeline.

In some aspects, unmanaged Iceberg tables working off of the Iceberg table format can share the same core create/refresh process as discussed herein. The disclosed auto-refresh process is multi-stepped, involving back-and-forth communication between a computer service manager (CSM) and execution platform (EP) to properly find the files to include and register in the table definition.

FIG. 5 is a block diagram 500 illustrating an Iceberg metadata registration process, in accordance with some embodiments of the present disclosure. FIG. 5 describes example processing phases 502, 504, 506, 508, and 510 which can be used in connection with database table auto-refresh.

Referring to FIG. 5, phase 1 (or processing phase 502) can be performed by a source monitor pipeline to access (or retrieve) a metadata file (e.g., a metadata file associated with a database table such as an Iceberg table), which can include the latest snapshot that is written and the corresponding manifest lists. In some aspects, phase 1 also performs schema changes. In some aspects, phase 1 can be a compute service manager (CSM) step (e.g., performed by a source monitor pipeline configured within the compute service manager 108).

In some aspects, processing phases 504-510 are performed by a refresh pipeline based on the input from the source monitoring pipeline. In phase 2 (or processing phase 504), a set of manifest files (e.g., based on the metadata file from phase 1) are queued to be processed by an execution platform (EP) (e.g., a refresh pipeline configured to execute on the execution platform 110) where the information is translated into internal inventory files (e.g., files that are native to and can be accessed/processed within the execution platform 110). In some aspects, the inventory files containing information about data deletion will be rewritten at phase 2.5 (or processing phase 506) (within the CSM) in the case of an incremental refresh. In some aspects, phase 3 (or processing phase 508) can utilize the inventory files for conversion into EP metadata files that are used by the network-based database system 102. In phase 4 (or processing phase 510), the CSM will commit a new table version with the newly registered and deregistered data files based on the EP metadata files to complete the table auto-refresh.

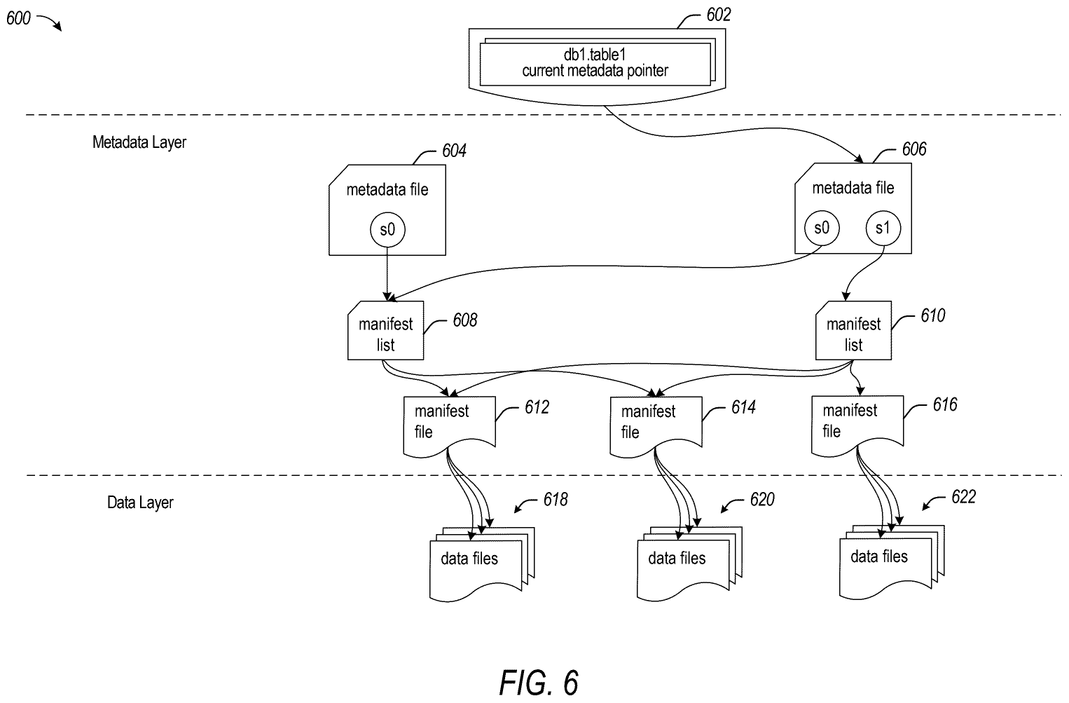

FIG. 6 is a block diagram 600 illustrating files defining an Iceberg table, which can be used in connection with the present disclosure. FIG. 6 illustrates the various files that can be used to interpret the canonical list of data files representing the Iceberg table.

Referring to FIG. 6, data files 618, 620, and 622 (of the data layer) may be in any format, including Parquet format. The metadata layer for the Iceberg specification includes metadata files 604 and 606 that list different snapshots (e.g., s0 and s1, as illustrated in FIG. 6) of the table. Each snapshot can point to a corresponding manifest list (e.g., manifest lists 608 and 610) containing the relevant manifest files (e.g., manifest files 612, 614, and 616). Each of the manifest files points to the final data files. The current metadata pointer 602 for a table can be implemented differently for each system.

The description below outlines how each Iceberg table type can maintain an interpretation of the metadata layer, which can be used during the disclosed auto-refresh processing to automatically get and process the latest table version.

Table 1 below lists an example pseudo-code for creating a Glue Iceberg catalog integration and table, followed by a refresh for the table.

```
TABLE 1
Unset
CREATE CATALOG INTEGRATION glue_catalog_integration
  CATALOG_SOURCE = GLUE
  TABLE_FORMAT = ICEBERG
  GLUE_AWS_ROLE_ARN = ‘<arn-for-AWS-role-to-assume>’
  GLUE_CATALOG_ID = ‘<glue-catalog-id>’
  [ GLUE_REGION = ‘<AWS-region-of-the-glue-catalog>’ ]
  CATALOG_NAMESPACE = ‘<catalog-namespace>’
  ENABLED = TRUE;
CREATE ICEBERG TABLE table_with_glue_integration
  EXTERNAL_VOLUME = ‘exvol’
  CATALOG = ‘glue_catalog_integration’
  CATALOG_TABLE_NAME = ‘glue_table’;
ALTER ICEBERG TABLE table_with_glue_integration REFRESH;
```

In some aspects, information is provided about maintaining the connection to the AWS Glue catalog to create the catalog integration. Information is also provided about the catalog namespace to optionally narrow the namespace of tables created under this catalog integration.

In some aspects, only the Glue table name is provided as additional information for the catalog connection to create the table. Combining the information from the catalog integration and the table name provides enough information to make the AWS Glue client call to get metadata information about the specified table. As a result, subsequent REFRESH commands do not need further qualifying information.

In some aspects, AWS Glue can be used to automatically manage the pointer to the latest Iceberg table metadata file, as described in the above section. So long as the customer-provided Glue information about the table is maintained, the FPM can make client calls to get the file location of the latest Iceberg metadata file.

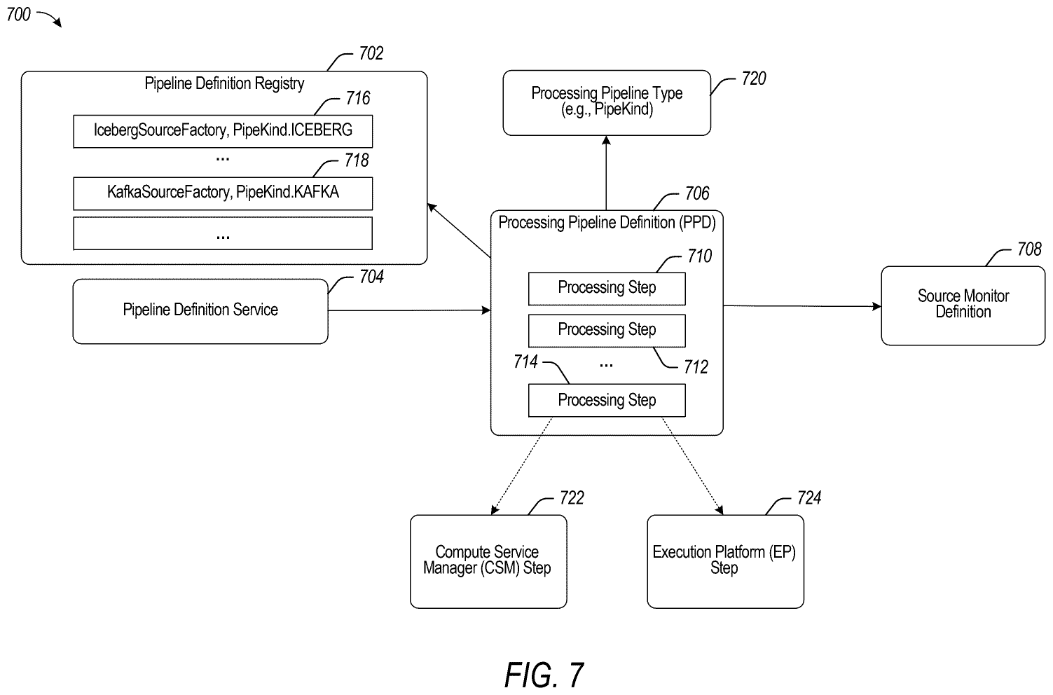

The disclosed pipe processing framework can be used in connection with discrete work processing. The disclosed pipeline generalization framework can be summarized as follows:
(a) Pipeline processing jobs are defined in CSM as a pipe definition (also referred to as a pipeline processing definition or PPD). PPDs can include multiple steps (or processing steps). The processing steps can operate on work items that are enqueued and dequeued across steps. PPDs can have a source monitor definition to periodically execute logic (e.g., implementing a source monitor pipeline) to enqueue new work items.
(b) Processing steps can execute logic on CSM or EP. CSM steps can be lightweight (e.g., CSM steps are single-threaded). EP steps can execute jobs using the continuous scanset model. A more detailed description of a PPD is provided below in reference to FIG. 7.

FIG. 7 is a block diagram of a system 700 for configuring a processing pipeline definition (PPD) 706 used by a file processing service, in accordance with some embodiments of the present disclosure. Referring to FIG. 7, FPM 128 can configure a pipeline definition service 704, which can configure a PPD 706 associated with at least one workload. In some aspects, the at least one workload can be retrieved using a manifest file (e.g., a manifest file detected in the queue service 404 and transferred to the pending queue 412).

In some aspects, the pipeline definition service can include functionalities of the pipe executor 414, including the task calculator 418 and the task scheduler 420. In some aspects, the pipeline definition service 704 can determine tasks associated with a workload (e.g., based on generating a query plan for the workload) and can determine slots in a virtual warehouse that can be used to execute the determined tasks. In some aspects, these functionalities can be configured as processing steps 710, 712, . . . , 714 of the PPD 706 associated with the workload.

In some aspects, a single instance of a PPD can be configured for a given processing pipe at any point in time (e.g., as a refresh pipeline to perform database table auto-refresh when a new workload is detected by a source monitor pipeline, such as a metadata file of the database table). If work items are in the pending queue, FPM 128 can execute the set of processing steps 710, . . . , 714 in order.

In some aspects, each of the processing steps can be configured as a compute service manager (CSM) step 722 or as an execution platform (EP) step 724.

In some aspects, the CSM step 722 is configured to execute at the compute service manager 108 and can be associated with the following functionalities:
(a) Can be configured to call out to external or internal services;
(b) Can be configured as single-threaded;
(c) Can be configured to execute without parallelism; and
(d) Can be avoided for resource-intensive operations.

In some aspects, the EP step 724 is configured to execute at the execution platform 110 and can be associated with the following functionalities:
(a) Creates processing jobs that run on execution nodes of the execution platform 110;
(b) Each of the processing steps of the PPD 706 can have a different query plan and associated processing jobs that can be configured to execute sequentially and/or in parallel using one or more slots (e.g., processing cores) of one or more execution nodes of the execution platform 110;
(c) Each of the processing steps of the PPD 706 can be configured to scale differently;
(d) The processing jobs of one or more of the processing steps can be configured to execute based on full parallelism of the file processing system; and
(e) Each of the processing steps can include one or more configurations for handling processing job failures.

In some aspects, FPM 128 can configure PPD 706 to also include configuration information indicating job completion or checkpoint configurations (e.g., configuring one or more functionalities to be performed or outputs generated at a specific checkpoint during the execution of the processing steps 710, . . . , 714 or after completion of the processing steps).

In some aspects, users can decide to poll the source and either push a work item to the pipe directly for processing based on the PPD or requeue the source monitor for execution.

In some aspects, the pipeline definition service 704 can be configured with a factory interface used to construct an instance of a PPD. The workload can provide an implementation. In some aspects, the job factory definition can be registered with the pipeline definition registry 702.

In some aspects, an instance of the PPD can be configured for a given entity ID. The entity ID can be a processing pipeline ID for which a processing job is being created. Implementations may use this as an opportunity to either create a new instance per invocation, share an instance across invocations, or implement a singleton across all processing pipes. Depending on the option chosen, different levels of optimizations and consolidation of work can be done.

In some aspects, a workload (and the corresponding PPD, such as PPD 706) can be associated with a processing pipeline type 720 (also referred to as PipeKind). In some aspects, the processing pipeline type 720 can include an Iceberg type (e.g., when the data is Apache Iceberg tables data stored in an Iceberg catalog), KAFKA type (e.g., when the data is KAFKA topic or another type of KAFKA data), or another type.

In some aspects, the PPD 706 and its associated processing pipeline type 720 can be registered in the pipeline definition registry 702, creating a definition registration. For example, pipeline definition registry 702 includes definition registrations 716, . . . , 718. A definition registration can be used to generate (or instantiate) a PPD instance and configure pipeline processing of the type indicated by the processing pipeline type 720. In some aspects, the processing pipeline type 720 (e.g., as indicated in a definition registration) can be used to configure specific (e.g., pre-defined) compute resources (e.g., a specific execution node or nodes, specific number of slots/cores of the execution node, and/or other types of compute resources) that can be used for executing the processing jobs associated with one or more steps of the PPD.

In some aspects, any of the definition registrations can be used to obtain a corresponding PPD from the registration as a pre-configured PPD based on the data type for a new workload (e.g., the workload data type can be matched with the processing pipeline type of a definition registration, and the corresponding PPD of the definition registration can be used to process the workload).

In some aspects, new workloads will extend the PPD abstraction and provide the steps necessary to process a work item. The core logic of the workload can be configured as part of the processing steps of the PPD.

In some aspects, a new workload can be associated with a corresponding pipe kind, and instances of that kind (pipe instance) to which work items will be pushed (similar to file ingestion performed by a file processing system).

For example, a KAFKA pull connector instance can be associated with a processing pipe that a user can create, pointing to a source and the inline transformations. When one or more items are pending in the pending slice of this pipe, the FPM 128 can schedule a PPD instance (if one is not already running) and execute the steps of the PPD.

In some aspects, a given processing pipe associated with a PPD can have at most one instance of a PPD active at a time. In some aspects, more than one instance of the job can be configured, or nested jobs can be configured.

In some aspects, a PPD can be initialized the same way that ingest works, which is that a work item can be pushed to a processing pipe. In other aspects, a workload can implement a monitoring and initialization mechanism by authoring a separate PPD as the source monitor definition.

In some aspects, a work item class can be used to pass work across processing steps and can be based on the following pseudo code listed in Table 2 below.

```
TABLE 2
Java
/** Represents a work item for a step in a PipeDefinition */
public class WorkItem {
/** Blob that has serialized workload-specific data for the work item */
private final byte[ ] data;
/**
User-specified properties for this work item. This will help avoid
deserializing the blob to look up information that could be useful for
batching work during the processing of a step.
*/
private Map<String, Object> properties;
public WorkItem(byte[ ] data) {
  this.data = data;
}
public WorkItem(byte[ ] data, Map<String, Object> properties) {
  this(data);
  this.properties = properties;
}
/** Gets the workload specific data */
public byte[ ] getData( ) {
  return data;
}
/** Gets a property value */
public Object getProperty(String key) {
  return this.properties.getOrDefault(key, null);
}
}
```

In some aspects, work items originating from the processing pipe's database-backed queue are represented using a Source WorkItem class. These work items have identifiers assigned by the file processing service, which will help the workload mark them as complete and remove them from the pending queue. In some aspects, the Source WorkItem class can be configured based on the pseudo code listed in Table 3 below.

```
TABLE 3
Java
/**
Implementation for the original work item that was queued to the pipe.
The addition is an ID that is assigned to the work item, which will be
later used for completion (removing the item from the queue).
*/
public final class SourceWorkItem extends WorkItem {
  /** Id assigned to this work item by the file processing system */
  private String id;
SourceWorkItem(String id, byte[ ] data) {
  super(data);
  this.id = id;
}
/** get the Id for the work item */
public String getId( ) {
  return id;
}
}
```

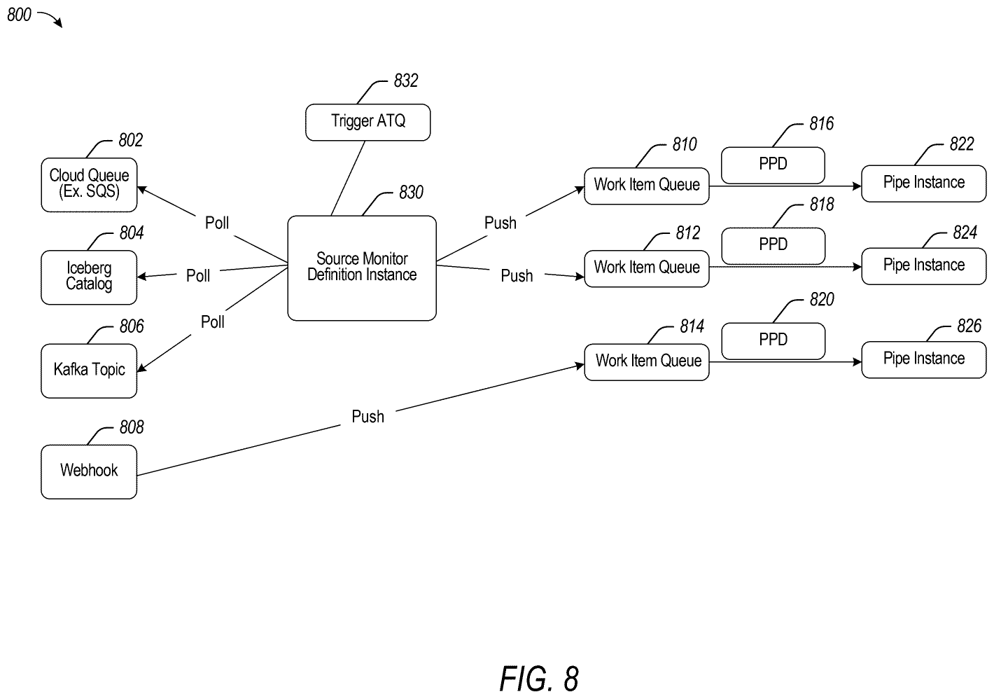

In some aspects, PPD 706 can be associated with a source monitor definition 708, which can be used to configure a source monitor (e.g., as discussed in greater detail in connection with FIG. 8-FIG. 10 and FIG. 26). In some aspects, the source monitor definition 708 can be implemented as a pipe processing job. It can be executed/run on a schedule.

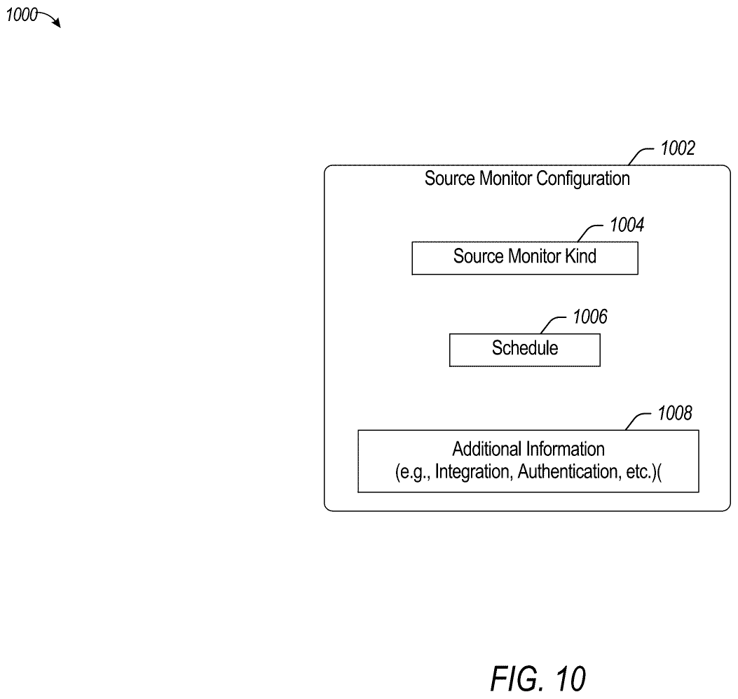

FIG. 8 is a block diagram 800 of a source monitor definition instance associated with a PPD in a file processing service, in accordance with some embodiments of the present disclosure. Referring to FIG. 8, the source monitor definition instance 830 can be configured (e.g., based on a source monitor configuration as illustrated in FIG. 10) to monitor and poll data sources to detect the presence of new or updated data. In some aspects, the source monitor configuration is based on a source monitor definition (e.g., source monitor definition 708).

For example, source monitor definition instance 830 can be configured as a source monitor pipeline to poll cloud queue 802 (e.g., Amazon SQS), an Iceberg catalog 804, and a KAFKA topic 806. Detected new/updated data can be pushed to corresponding work item queues 810 and 812 (e.g., in the form of metadata files, such as manifest files, based on the type of data that is fetched). In some aspects, new or updated data can be directly pushed into a queue (e.g., webhook 808 pushes data directly into work item queue 814 without the use of the source monitor definition 708).

In some aspects, the Iceberg catalog 804 can include one or more snapshots. In some aspects, the KAFKA topic 806 includes partitions. Multiple partitions can be pushed to the same work item queue. A KAFKA pull-based connector of the source monitor definition instance 830 can reserve a slot for each partition and indicate the number of slots needed to process the pulled partition(s) once they are stored in the work item queue.

The source monitor definition instance 830 can monitor for new data and push the detected data to a work item queue, as well as provide an indication of the pushed data type so that a processing pipe instance of the same kind can be instantiated using a PPD.

Work item queues 810, 812, and 814 can be used (e.g., by the pipeline definition service 704) to generate corresponding PPDs 816, 818, and 820. Corresponding pipe instances (or PPD instances) 822, 824, and 826 can be configured based on PPDs 816, 818, and 820.

In some aspects, the source monitor definition instance 830 can be instantiated based on a trigger asynchronous task queue (ATQ) 832. For example, the trigger ATQ 832 can be configured to instantiate/trigger source monitor definition instance 830 periodically or at a specific instance.

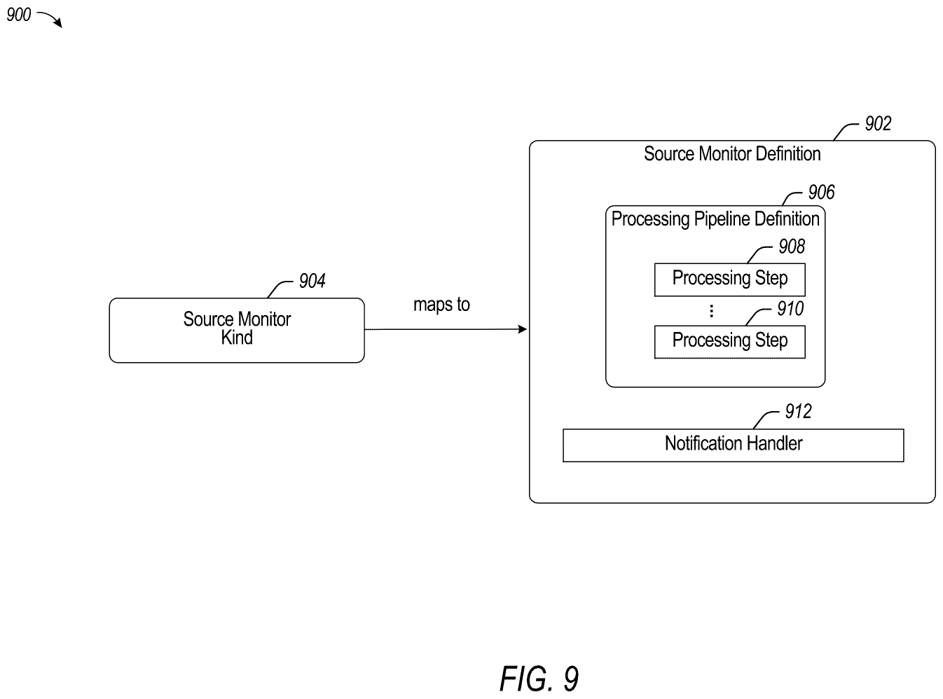

FIG. 9 is diagram 900 of a source monitor kind data structure that maps to a source monitor definition, in accordance with some embodiments of the present disclosure. Referring to FIG. 9, the source monitor kind data structure 904 (also referred to as a source monitor kind or SourceMonitorKind) can be mapped to a source monitor definition 902. In some aspects, the source monitor definition 902 includes PPD 906 with processing steps 908, . . . , 910. In some aspects, the PPD 906 can be configured as a multi-step processing job to fetch notifications.

In some embodiments, a new source monitor can be created by adding a new kind to the source monitor kind and defining an associated source monitor definition 902 (also referred to as SoureMonitorDefinition). The pipe's definition can determine the source monitor kind for the pipe. As an example, an unmanaged Iceberg table pipe (which uses a Glue catalog) will return the ICEBERG_SOURCE_GLUE_CATALOG kind, whereas a pipe using a different catalog will return a kind corresponding to it.

In some embodiments, each of processing steps 908, . . . , 910 can be performed as a CSM step 722 or an EP step 724.

In some aspects, the source monitor definition 902 also includes a notification handler 912, which can be configured to handle matching, deduplicating, and forwarding notifications to one or more pipes. The notification handler 912 can be configured to filter the notifications fetched by the processing steps of PPD 706. As used herein, the term “notification” can include new or updated data that is detected as available at a data source or a message indicating the availability of such new or updated data.

In some aspects, the notification handler 912 is further configured to perform the following functionalities:
(a) determine whether the notification is associated with data that should be skipped (e.g., ignored) or processed;
(b) forward the notifications to one or more processing pipes that match (e.g., one or more matching criteria) for a specific notification;
(c) determine whether the fetched data should be stored as single or multiple items in a work item queue;
(d) determine whether the fetched data should be stored in a single or multiple work item queues; and
(e) determine whether to perform deduplication.

In some aspects, a SourceMonitorDefinition can be configured as a specialized extension of a processing pipe job. In some aspects, a processing pipe job is initialized when there is a work item in the pending queue. In comparison, source monitors have an implicit perpetual work item in the pending queue and can always be running, a SourceMonitorConfiguration, which is defined by the pseudo code in Table 4 below, is the implicit work item that is used to start the monitoring.

In some aspects, a source monitor can be configured to provide match criteria or conditions that can be evaluated against incoming notifications to determine if it matches any active pipe. If deduplication is required, it can be done in this layer. Upon receiving the notifications from the steps defined in the base PPD, the notification is pushed via a forward notifications method. This method uses the match condition to determine the pipes to forward the notification to and will enqueue it to the pipe's pending queue.

An example pseudo code for configuring a source monitor definition is listed in Table 4 below.

TABLE 4
public abstract class SourceMonitorDefinition extends PipeDefinition {
SourceMonitorDefinition(MatchCondition matchCondtion) {
/**
Initialize match condition
*/
}
public MatchCondition getMatchCondition( ) {
// Returns the match condition which needs to be used for
}
/**
Implementation of forwardNotifications method.
Forward notifications support at least once semantics
Returns SourceMonitorResult which contains the following information.
- Status (Success/Failure)
- ErrorDetails (if failure)
- List of notifications that result is applicable to.
*/
SourceMonitorResult forwardNotifications(List<Notification> notifications) {
MatchConditon matchCondition = getMatchCondition( );
// Get the pipes that are associated with source monitor configuration.
List<Long> pipeIds = getPipes(sourceMonitorConfiguration)
// If notification matches to a pipe, then forward it.
for (notification : notifications) {
for (pipeld : pipeIds) {
if (matchCondition.matchNotification(pipeId, notification)) {
pushWorkItemToPipe(pipeId, notification.toWorkItem( ));
}
}
}
}
}
public abstract class MatchCondition {
boolean matchNotification(long pipeId, T notification) {
// Returns true if the current notification matches for a pipe, else
returns false.
// If match returns true then the notification will be translated to a work
item and
// written to the pipe's pending queue.
// Workloads which require de-duplication can handle it in this layer.
}
}
/**
Factory interface used to construct an instance of SoureMonitorDefinition. An
the workload provides implementation.
Factory should be registered with the PipeDefinitionRegistry.
*/
public class SoureMonitorDefinitionFactory {
public SoureMonitorDefinition getInstance(SoureMonitorConfiguration
configuration)
}

FIG. 10 is a diagram 1000 of a source monitor configuration 1002, in accordance with some embodiments of the present disclosure. Referring to FIG. 10, the source monitor configuration 1002 can be associated with a pipe dictionary object. It can be used to encapsulate information that can be used to start a source monitor (e.g., by instantiating a source monitor definition instance). More specifically, source monitor configuration 1002 includes credentials/integrations for the monitoring job as well as frequency/lag between runs.

In some aspects, the credentials/integrations for the monitoring job can be a source monitor kind 1004, which maps to a source monitor definition (e.g., source monitor definition 902). The source monitor kind 1004 can be used to instantiate a source monitor definition instance based on the source monitor configuration it maps to.

The source monitor configuration 1002 also includes scheduling information 1006, which can indicate the frequency/lag between successive monitoring job runs. In some aspects, the scheduling information 1006 can be user-defined. In other aspects, it can be system-defined. In some aspects, the schedule of the trigger ATQ 832 can be used to schedule monitoring job runs.

In some aspects, the source monitor configuration 1002 includes additional information 1008, which can include integration information associated with the data source. In some aspects, the integration information can include authentication information which can be used for accessing the data source to perform polling for new/updated data stored in the data source during at least one notification fetching job (e.g., during one or more of the processing steps 908, . . . , 910 of PPD 906).

In some aspects, a source monitor configuration is associated with a pipe dictionary object, which encapsulates the information required to start the monitoring job. More specifically, it has an ID, credentials/integrations needed by the monitor, and frequency/lag between runs. This information can be used to create an instance of a source monitor definition and schedule it. If multiple pipes share the same configuration, then such configuration can be optimized and run efficiently.

In some aspects, the following pseudo code in Table 5 can be used to generate a source monitor configuration.

TABLE 5
public abstract class SoureMonitorConfiguration {
// Return the kind for the SourceMonitor.
SoureMonitorKind getSoureMonitorKind( ) {
// Kind will determine the SoureMonitorDefinition that will be used for
this pipe.
}
// Returns a unique id for the running monitor.
String getSourceMonitorId( ) {
// Pipe's sharing the same configuration should preferably return the same
id
// for efficient scheduling.
// Get the lag duration.
Duration getLagDuration( )

In some aspects, a source monitor pipe can be configured to read Iceberg metadata (e.g., a .json file) using an Iceberg SDK as a CSP step. In some aspects, the source monitor pipe is also configured to find the latest snapshot written and extract the corresponding snapshots that can be used by the refresh pipeline for the database table auto-refresh. In some aspects, each snapshot is enqueued as a work item to the consuming pipe (e.g., a refresh pipeline, which can also be referred to as Iceberg metadata refresh pipeline).

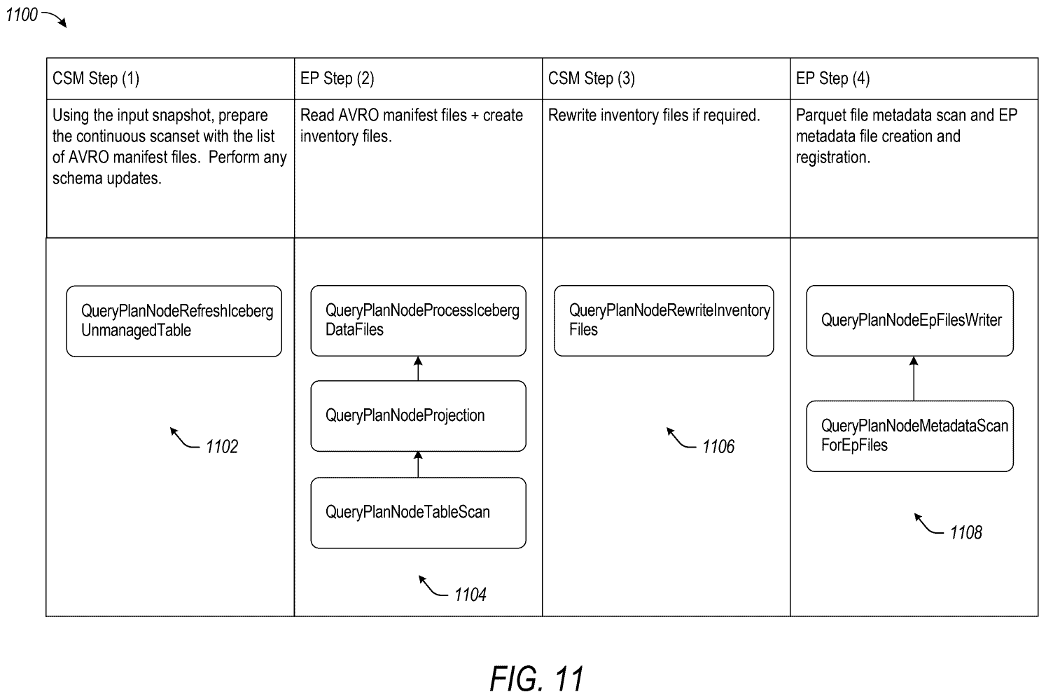

In some aspects, the refresh pipeline is configured to perform the four processing steps (e.g., processing steps 1102, 1104, 1106, and 1108) illustrated in FIG. 11. In some aspects processing step 1102 maps to processing phase 502, processing step 1104 maps to processing phase 504, processing step 1106 maps to processing phase 506, and processing step 1108 maps to processing phases 508 and 510.

FIG. 11 is a diagram 1100 of processing steps and corresponding query plan nodes performed by a refresh pipeline, in accordance with some embodiments of the present disclosure.

In some aspects, a refresh pipeline can be configured to perform the four processing steps illustrated in FIG. 11 as processing steps (1)-(4). For this pipe, the work item is on a snapshot level (as can be initialized by the source monitor pipeline). FIG. 11 also illustrates query plan nodes 1102, 1104, 1106, and 1108, corresponding to processing steps (1)-(4).

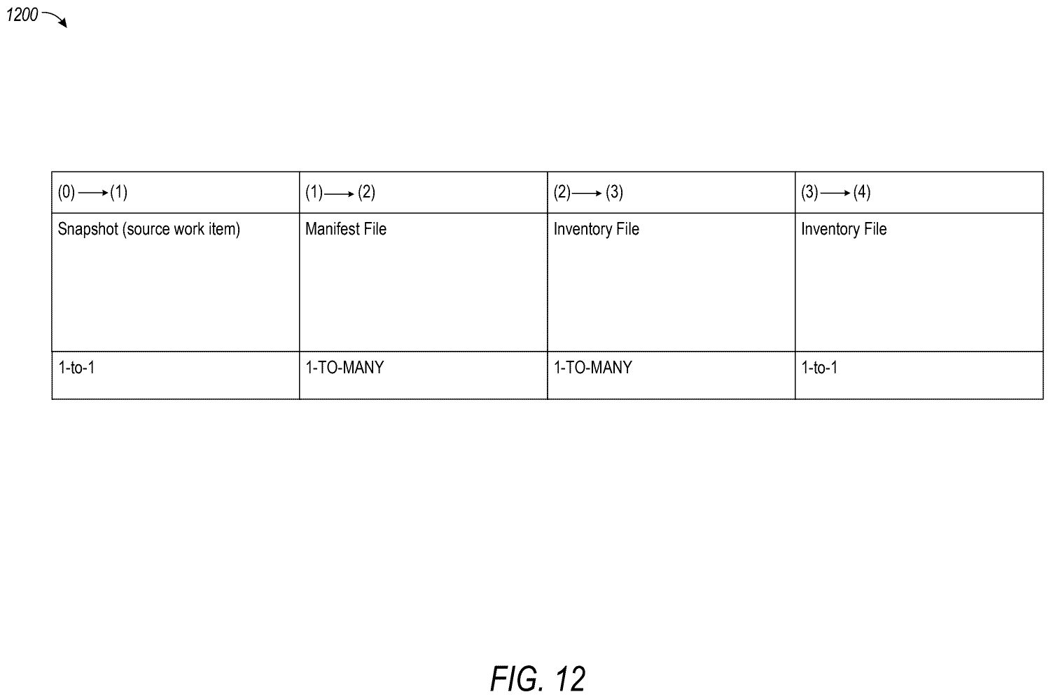

FIG. 12 is table 1200 illustrating the evolvement of a work item during the processing steps performed in the refresh pipeline, in accordance with some embodiments of the present disclosure. More specifically, FIG. 12 depicts how the work item evolves between each processing step and the cardinality relationship corresponding to a single instance of the previous work item. In FIG. 12, processing step (0) is performed by a source monitor pipeline (also referred to as a source monitor), and steps (1)-(4) are performed by a refresh pipeline.

In some aspects, discrete steps can be executed for the bootstrap and incremental refresh process that can be configured by the disclosed pipe processing framework.

Resource monitoring can be configured via the source monitor definition framework for both the Glue Iceberg and Loose Iceberg scenarios. Since the disclosed techniques can support different catalog integration types, resource monitoring functionalities can be agnostic to the catalog type.

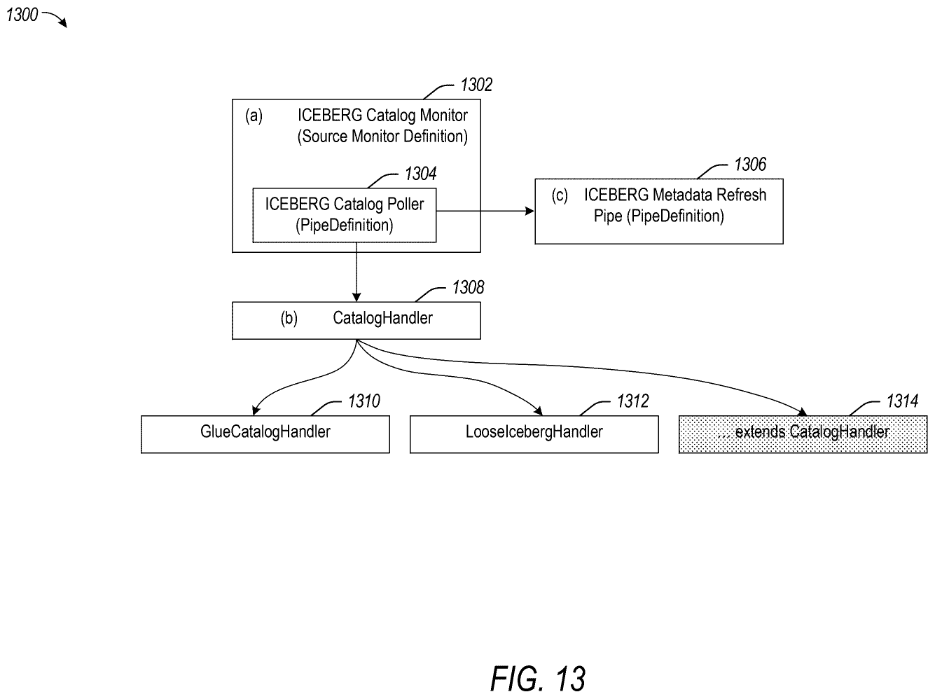

FIG. 13 is a block diagram of an Iceberg table auto-refresh architecture 1300, in accordance with some embodiments of the present disclosure. Referring to FIG. 13, the Iceberg table auto-refresh architecture 1300 includes a source monitor definition 1302, a notification handler 1308, and a refresh pipeline 1306. The source monitor definition 1302 includes an Iceberg catalog poller 1304. The notification handler 1308 can include handlers 1310, 1312, . . . , and 1314 for different types of notifications associated with different types of database tables.

In some aspects, the source monitor definition 1302 is agnostic to the actual catalog implementation. The monitor will carry information about the catalog integration (such as the Catalog Integration ID) and, through the polling process, request the latest metadata file from the integration. In some aspects, the notification handler 1308 will be used to execute the actual work that the polling process requests. Depending on the integration metadata, a different handler implementation may be used to access the latest metadata. If a new metadata file is detected, the source monitor pipeline will forward the notification (and the information on where the new metadata file is) to the refresh process performed by the refresh pipeline 1306.

An example processing flow performed by the Iceberg table auto-refresh architecture 1300 can include the following functionalities (which can be performed by the FPM 128):
(a) A source monitoring pipeline is configured for the catalog-based Iceberg table for source monitoring and refresh.
(b) The source monitor is scheduled to poll the catalog.
(c) Polling commences (e.g., using Iceberg catalog poller 1304) and queries for the latest metadata file.
(d) The notification handler 1308 loads the integration for the pipeline processing job.
(e) The notification handler 1308 will use the catalog integration (if needed) to obtain the latest metadata file of the Iceberg table. For Glue Iceberg, this will include using a Glue client to query AWS. For Loose Iceberg, processing details are provided below.
(f) The latest metadata file will be filtered against the current metadata file registered for the table and forwarded to the refresh steps (e.g., the refresh pipeline 1306).
(g) The table is incrementally refreshed, and processing can resume at step (a) above.

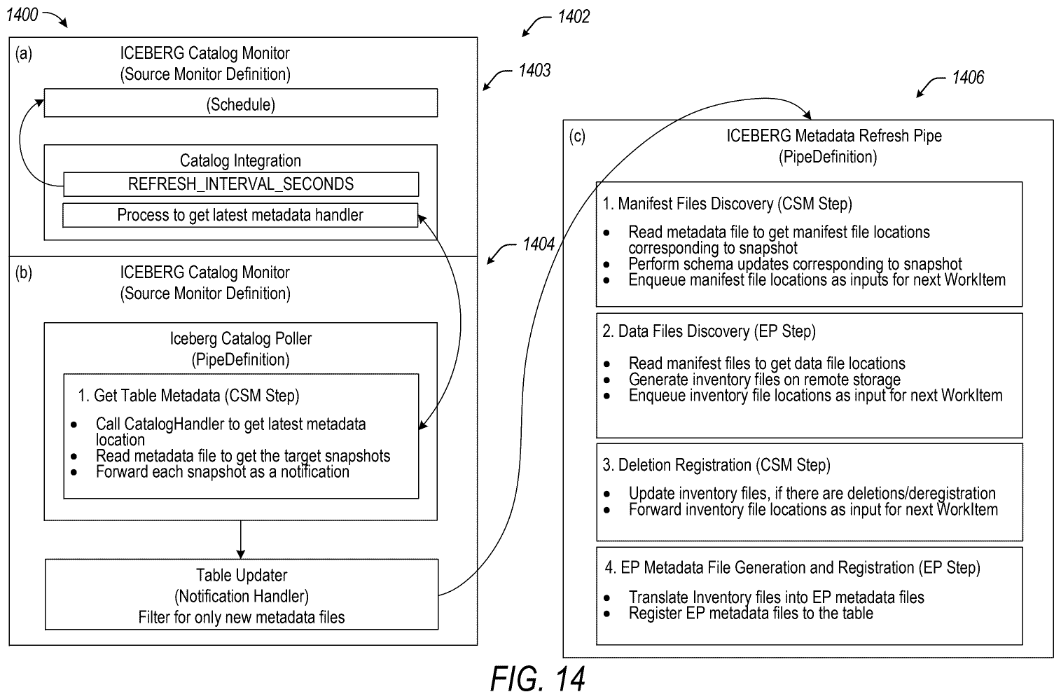

FIG. 14 is a block diagram of an implementation outline of an Iceberg table auto-refresh architecture 1400, in accordance with some embodiments of the present disclosure. Referring to FIG. 14, the Iceberg table auto-refresh architecture 1400 includes a source monitor pipeline 1402 and a refresh pipeline 1406.

The source monitor pipeline 1402 includes source monitor definitions 1403 and 1404. The source monitor definition 1403 can configure a scheduler and catalog integration. The source monitor definition 1404 can configure a processing pipe definition (PPD) for fetching metadata and a notification handler. The refresh pipeline 1406 can include a PPD to configure processing steps 1-4 (as referenced and described in FIG. 14).

In some aspects, the source monitor definition 1403 will link to the catalog integration configuration for scheduling and catalog-specific processes. In some aspects, the source monitor definition 1404 will poll the external Iceberg catalog and forward individual snapshots as a notification. These snapshots are filtered against the current snapshot and enqueued in lineage order.

In some aspects, the refresh pipeline 1406 will be the same regardless of the Iceberg catalog type. The initial work item for the pipeline processing job will only need to contain information about the table being updated and the snapshot itself. Upon completion of the pipeline processing job (e.g., auto-refresh completion), the table will be transactionally updated.

In some aspects, the first step in executing an automatic refresh will be to obtain the latest metadata file for a catalog. Between the Iceberg catalog monitor and the catalog integration, no additional input may be required.

In some aspects, getting the latest Iceberg metadata from Glue tables can be a simple process for manual refresh. This can be no different for auto-refresh, where a getLatestMetadataFile function can be used by the catalog handler.

In some aspects, the FPM can configure a bootstrap refresh with auto-refresh (CREATE ICEBERG TABLE . . . [REFRESH_INTERVAL_SECONDS=X]).

Similar to external tables, the intent of unmanaged tables is to maintain a view on a data lake table. For the same reasons AUTO_REFRESH=true by default for external tables, the end state for an auto-refresh for Iceberg can be such that once auto-refresh is configured, the default value of the REFRESH_INTERVAL_SECONDS table option can enable auto-refresh.

When creating a table with auto-refresh enabled, the entities for auto-refresh are created before the table creation is committed. If the auto-refresh setup fails, table creation can fail to ensure the consistency and safety of the data processing systems. This will prevent corrupted states where a table creation has been committed, but the underlying auto-refresh infrastructure is non-functioning. Outside of the main commit transaction, metadata for the processing pipe configurations can be prepared. In order to prevent race conditions between committing the new table and the auto-refresh operations, persisting the pipe data objects (PipeDPOs) can be done during the main table commit transaction.

In some aspects, the minimum value supported for REFRESH_INTERVAL_SECONDS can be the maximum of 1 second or the overhead time to process the smallest incremental refresh possible. In some aspects, no maximum value is specified. If a user specifies NULL, the REFRESH_INTERVAL_SECONDS value specified for the catalog can be used.

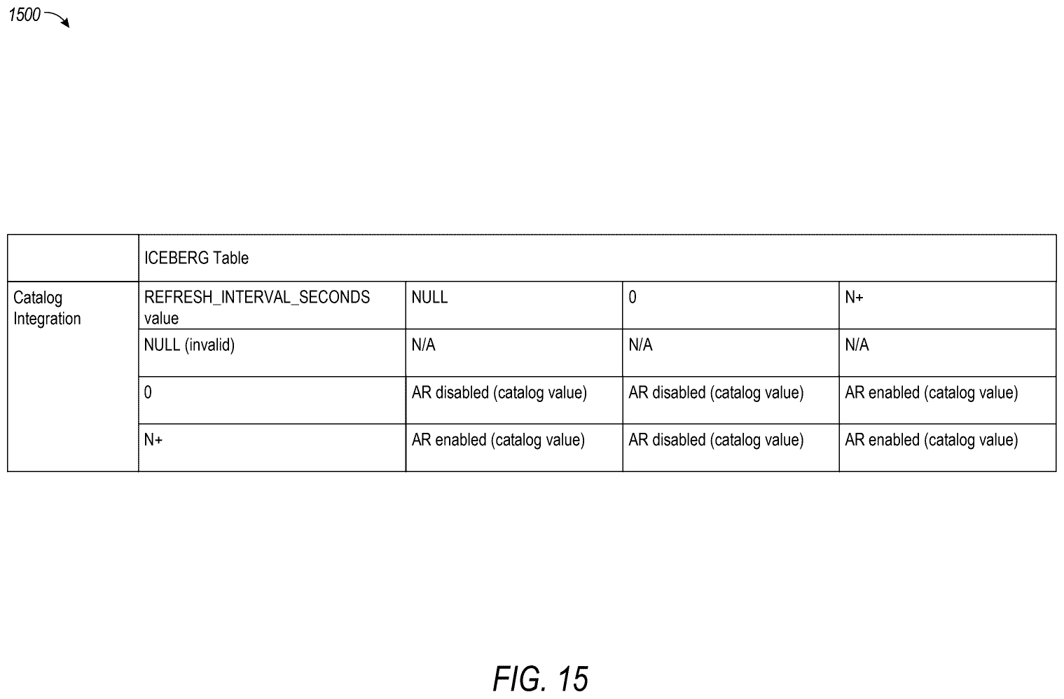

FIG. 15 is table 1500 illustrating configurations for bootstrap refresh with auto-refresh, which can be used with disclosed techniques, in accordance with some embodiments of the present disclosure.

In some aspects, FPM 128 enables auto-refresh using (ALTER ICEBERG TABLE . . . SET REFRESH_INTERVAL_SECONDS=X). If a user wishes to enable auto-refresh, the PipeDPOs can be created and persisted as outlined in the bootstrap refresh scenario above.

In some aspects, FPM 128 can disable auto-refresh using (ALTER ICEBERG TABLE . . . SET REFRESH_INTERVAL_SECONDS=0). If a user wishes to disable auto-refresh, the refresh pipeline jobs can be dropped/deleted.

Since auto-refresh can operate over user-owned resources, FPM 128 can attempt to detect when non-recoverable errors cause a persistent failure for auto-refresh operations and subsequently disable auto-refresh.

In some aspects, the processing pipe owner can correspond to the Iceberg table owner. This can be the same model used by external tables. In some aspects, the same ownership model can be used between external tables and Iceberg tables.

In some aspects, when table ownership changes (e.g., via the GRANT OWNERSHIP command), the auto-refresh pipelines can be dropped.

In some aspects, the command (DROP/ALTER ICEBERG TABLE . . . CONVERT TO MANAGED) can be used when the table is getting dropped or converted into a managed table (i.e., no longer needing the auto-refresh infrastructure).

In some aspects, the command (UNDROP) can be used when a user decides to undrop a table that has auto-refresh. In this case, the pipelines can be undropped along with the table in the same transaction. The scheduling slice for the pipe can be reverted to include the pipe again. Effectively undropping an Iceberg table with auto-refresh will return the table to a fully operational state.

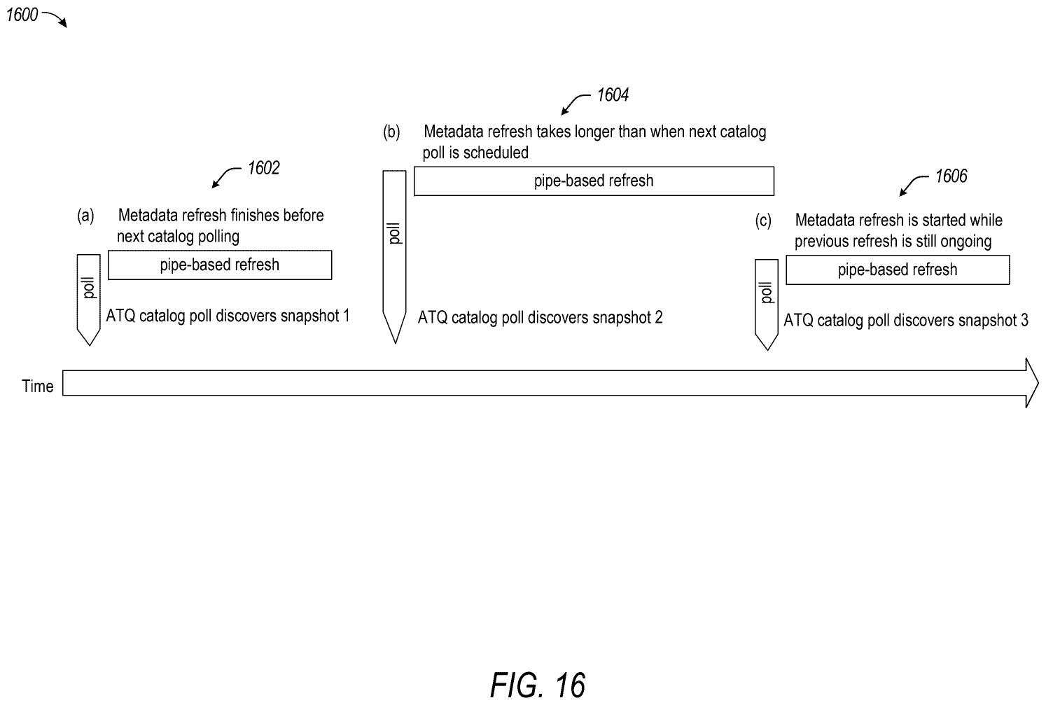

In some aspects, the refresh processing time can take longer than what is specified by the user. This is illustrated in FIG. 16. In this scenario, FPM 128 can consider the source monitor behavior when attempting to schedule another polling of the catalog. In some aspects, FPM 128 can support (1) concurrent refreshes in auto-refresh and allow the resource monitor to schedule catalog polls and pipe-based refreshes as normal or (2) skip subsequent refreshes until the last executing refresh is complete.

FIG. 16 is a diagram 1600 of an auto-refresh timeline where catalog polls lead to differently scaled workloads, in accordance with some embodiments of the present disclosure.

Referring to FIG. 16, at operation 1602, a “normal” auto-refresh terminates before the subsequent catalog polling takes place. At operation 1604, an auto-refresh is performed that takes longer than the catalog polling period. At operation 1606, if the source monitor is not intervened with, another pipe-based refresh would occur concurrently with the previous refresh.

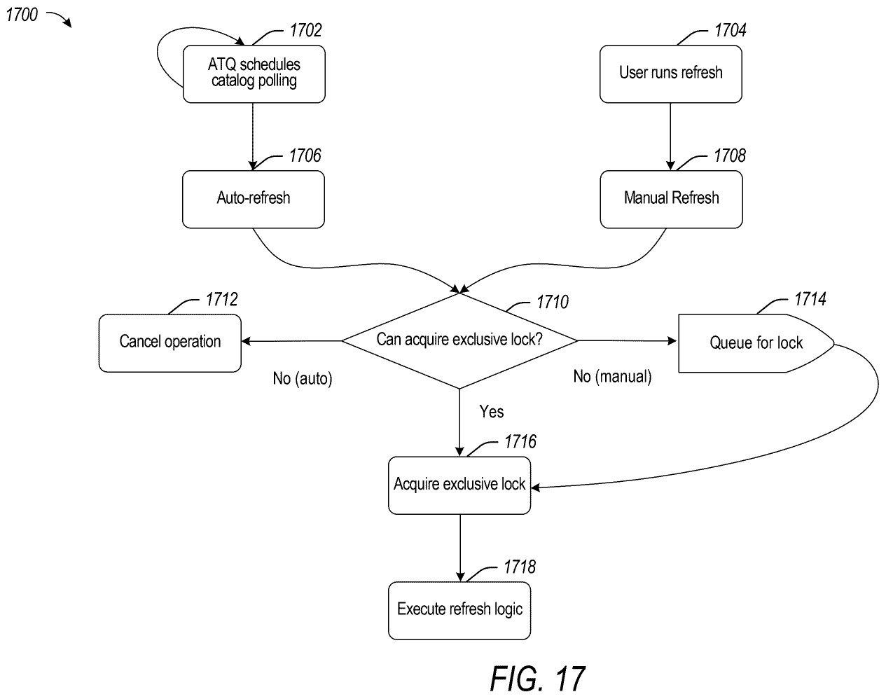

When refreshes are processed serially, processing can be performed based on operation 1604, where subsequent refreshes are skipped if a refresh operation is ongoing. This methodology also handles the scenario for handling coordination between manual and automated refresh (e.g., as illustrated in FIG. 17).

Accelerating refresh processing faster than this will involve integrating with heuristics and processes currently in design. For example, heuristics can be used to opt for a full refresh rather than an incremental refresh.

FIG. 17 is a flow diagram of a logical flow 1700 for coordinating an auto-refresh and a manual refresh when refreshes are requested while ongoing refreshes are still executing, in accordance with some embodiments of the present disclosure. Referring to FIG. 17, logical flow 1700 is based on operations 1702, 1704, 1706, 1708, 1710, 1712, 1714, 1716, and 1718, which are detailed in FIG. 17.

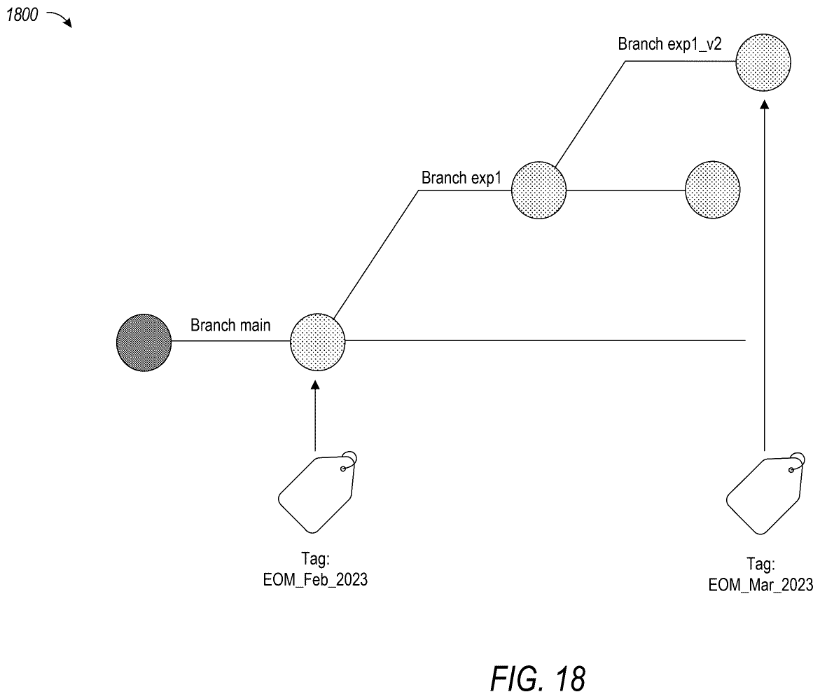

In some aspects, FPM 128 can configure the following Iceberg auto-refresh concurrency semantics discussed in connection with FIG. 18-FIG. 24.

Iceberg tables, similar to Git, allow for data version control through branching and tagging. These branches help manage different versions of data, facilitating operations like time travel and branch swapping without affecting the current snapshot displayed by the table.

When an update is applied to an Iceberg table, a new snapshot is created that tracks the updated data and captures the table's state. That is, whenever a table's state changes, a new snapshot is created to track it. These snapshots enable users to maintain divergent branches of data, work on several branches interchangeably, and time travel to any desired point in time. Tagging is an ability that enables users to refer to snapshots using named references.

FIG. 18 is a diagram 1800 of a data branching example of divergent branches in Iceberg, in accordance with some embodiments of the present disclosure.

In some aspects, Iceberg tables have a notion of “a current snapshot” that reflects the data they are currently displaying. Users can work on different branches in parallel without impacting other branches. That is, users can update a branch without these changes being reflected in the table and then switch to this branch later. The key distinction here is that while multiple branches can be maintained in the background, only one snapshot can ultimately be displayed by the table.

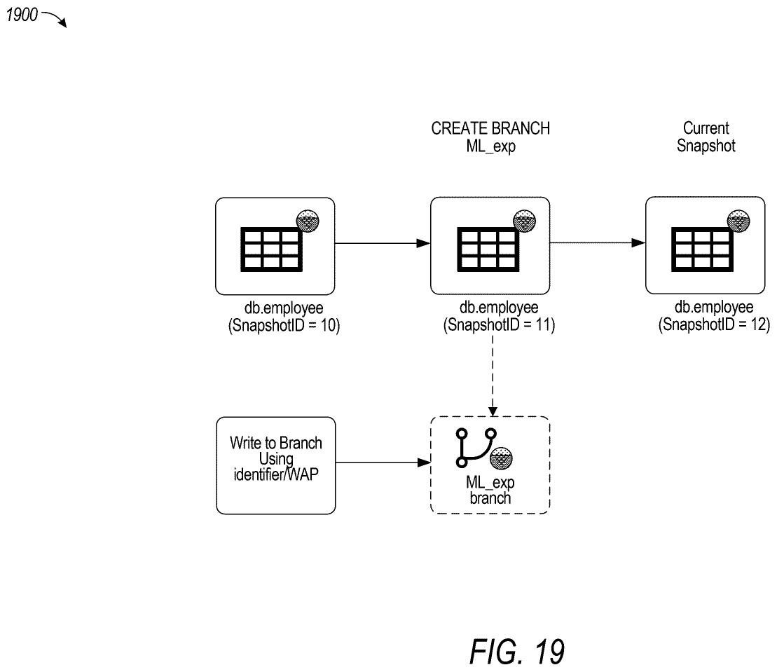

FIG. 19 is a diagram 1900 of a branch tracking example, in accordance with some embodiments of the present disclosure.

When refreshing tables from unmanaged tables, only the current snapshot's state can be reflected. However, Iceberg tables allow for branch swapping and time travel, necessitating adaptations for these dynamic changes. In some aspects, a complete refresh can be triggered by calculating and applying the differences between the current and target snapshots to align with the new branch state.

In some aspects, Iceberg tables can use a single branch data model, reflecting only the current snapshot. To update database tables to a new branch, manual refreshes (MRs) are necessary, as auto-refreshes (ARs) support incremental updates of the current branch. An MR handles both full branch changes through a diff and bootstrap process, and incremental updates without a bootstrap.

However, with AR, users can manually initiate MR for significant branch changes since AR cannot handle them automatically. This requirement modifies user workflows, demanding they strategically use MR alongside AR to ensure data integrity and avoid stalling the AR process. The disclosed techniques can use both refresh types to maintain table accuracy, especially for complex workloads that require frequent branch updates. This dual approach helps prevent data corruption by managing overlapping executions of AR and MR with appropriate locking mechanisms.

In some aspects, auto-refreshes and manual refreshes can be used in conjunction. The introduction of AR can change a customer workflow to the following:
(a) Change branches and time travel with auto-refresh.
(b) Force an update with manual refresh if necessary (i.e., ensure that data is updated before querying).
(c) Automatically refresh database tables with auto-refresh when the upstream Iceberg table is updated.

While customers of the network-based database system 102 can rely on MR for specific workloads, large workloads that require AR will also need to use MR for branch changes. This can lead to current refresh issues, as without the correct locking mechanisms in place, AR and MR can execute simultaneously, which can result in data corruption.

In some aspects, auto-refresh (AR) executions can happen concurrently with manual refresh (MR) executions. Parallel executions of AR can be impossible since mutual exclusivity (on the granularity of a singular table) is guaranteed by the source monitor and pipe coordinator. That is, only one instance of a pipe can refresh a table at a given moment in time. Similarly, parallel executions of MR can be impossible. At the beginning of all MR statements, a file lock can be acquired that completely blocks all further modifications of the target table. This guarantees serial order of refreshes and consequently ensures mutual exclusivity.

In some aspects, AR does not acquire any locks, and hence, race conditions that would cause data corruption can occur.

As used herein, the term “file lock” is defined at the table-level granularity and is almost always acquired at the beginning of execution. The primary use case is for Updates and Deletes, where file de-registration can occur. Since this lock is acquired at the beginning of execution, it guarantees the serial order of the execution phase. In most cases, it is still necessary to acquire the table lock even when a file lock is acquired to guarantee commit serialization.

As used herein, the term “table lock” is defined at the table-level granularity. However, it is always acquired at commit time (at the very end of execution). The primary use case is to guarantee the serial order of table versions (i.e., no concurrent table updates can be committed). This lock can be viewed as a logical atomic counter that tracks the version number for the table version data object (or Table VersionDPO). Since this lock is only acquired at commit time, it does not guarantee serial execution, and overlapping is possible. However, it does guarantee serial commits. This can be used for Inserts, where file de-registration is not possible, and a blind update is performed.

The term “parent and child job” can be used in connection with manual refreshes. If the FPM is processing a metadata file with N>=2 snapshots, then the FPM will spawn N child jobs, each responsible for processing a single snapshot. If there is precisely a single snapshot to process (N=1), then we will spawn a singleton job (this is inherently a parent job with a single child).

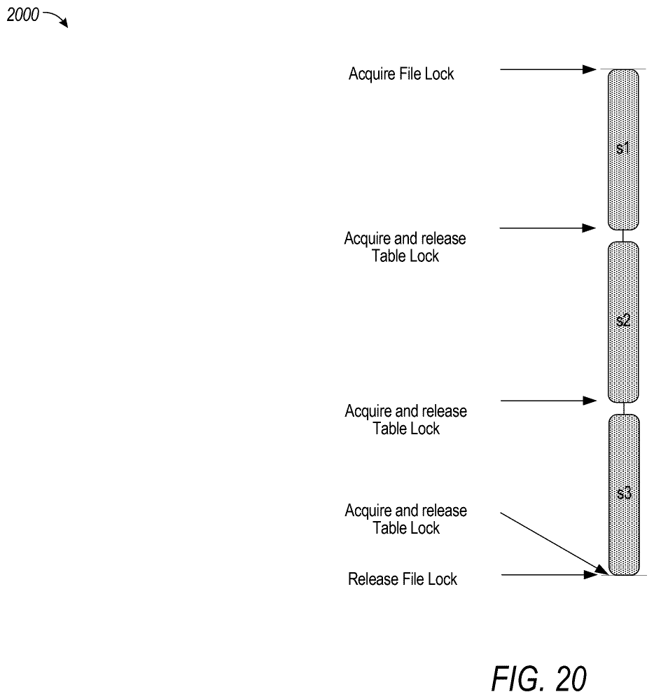

FIG. 20 is a diagram 2000 of lock acquisition and release timelines of a manual refresh for three snapshots of an Iceberg table, in accordance with some embodiments of the present disclosure.

In an MR, a file lock is acquired at the beginning of the parent job and then released when the parent job is completed. A parent job is completed when all child jobs are processed. For each child job that processes a singular snapshot, a table lock is ephemerally acquired and released at commit time to ensure commits are serialized.

In some aspects, table locks may not be strictly necessary. Since the FPM acquires a file lock at the beginning of the parent job, no updates can occur to this table until all snapshots are done processing. That is, concurrent MR executions are not possible since mutual exclusivity is guaranteed.

In some aspects, no locks can be acquired. In some aspects, the FPM can lock around the boundaries of a snapshot.

When AR is configured, the source monitor handles the equivalent of a “parent” job (orchestrating the snapshot), and the refresh pipe handles the equivalent of a “child job” (processing individual snapshots). This separation of concern means that the source monitor can be responsible for splitting up the snapshots, and the child job is responsible for processing these snapshots. That is, the source monitor has no awareness of the state for snapshots that it enqueues.

Additionally, the source monitor maps to multiple pipes, with each pipe mapping to a singular table. This means that the “parent” equivalent for AR spans multiple tables, whereas if MR is configured, each parent job handles a singular table. For these reasons, it may not be feasible to lock all tables that a source monitor (SM) enqueues to. Not only could there be too many tables to manage, but the source monitor is also isolated from the actual refresh process. Communication of state between the SM and the refresh pipe (RP) would break abstraction.

In other words, if the SM detects snapshots and then enqueues them to the pending slice, we cannot guarantee that all 3 snapshots will be processed atomically as a singular unit in the RP. In some aspects, each snapshot will not be interrupted, which can be done by acquiring file locks at the beginning of a snapshot and releasing them at the end.

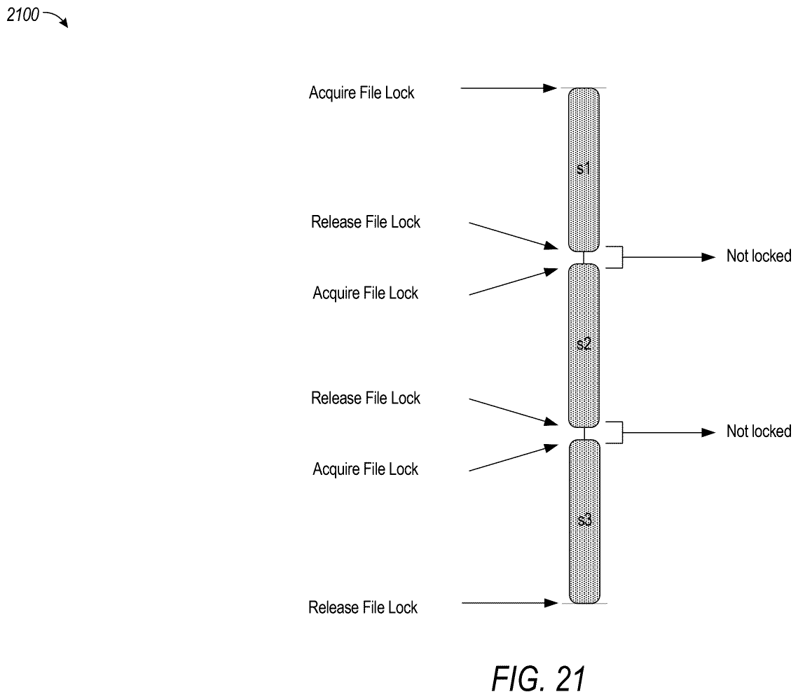

FIG. 21 is a diagram 2100 of lock acquisition and release timelines of an auto-refresh for three snapshots of an Iceberg table, in accordance with some embodiments of the present disclosure.

FIG. 21 indicates that when processing N snapshots, there are N−1 intervals where no locks are held. In these gaps, interrupts from MR can cause the interleaving of other snapshots.

As seen in the previous section, interrupts may occur when processing snapshots in the AR case. The MR case guarantees that the “world view” observed by the parent job will be processed atomically without interruptions. This invariant is not honored in the AR case since the “world view” observed by the SM is not guaranteed to be processed atomically in the RP. The gaps in between each snapshot introduce potential race conditions where the “world view” can be interrupted by other snapshots.

In some aspects, the FPM can allow interrupts to happen and honor them by performing a refresh to the interrupting snapshot. Interrupts may not necessarily have to be next in lineage, as a time-traveling interrupter can also be honored by performing a bootstrap refresh. In other words, the FPM can also support non-incremental interrupters.

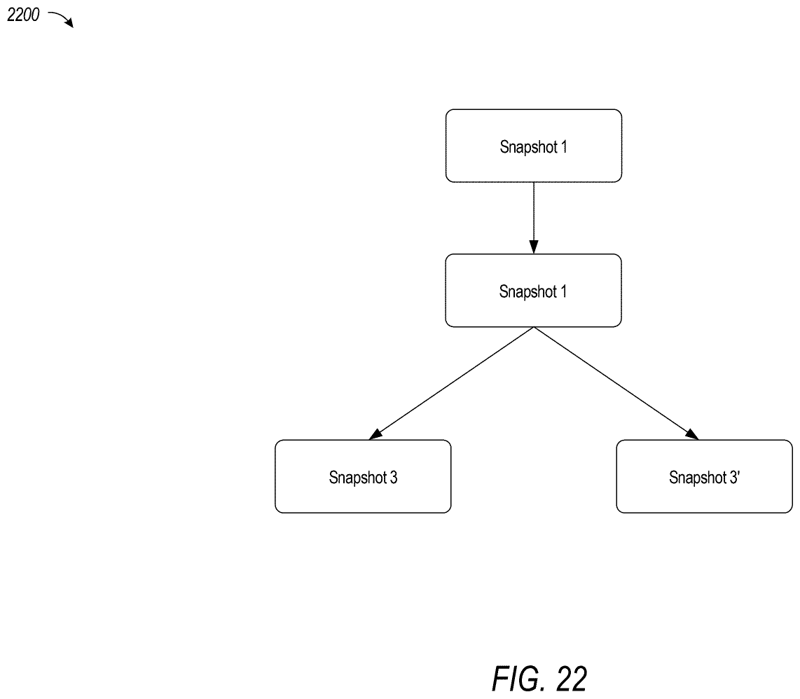

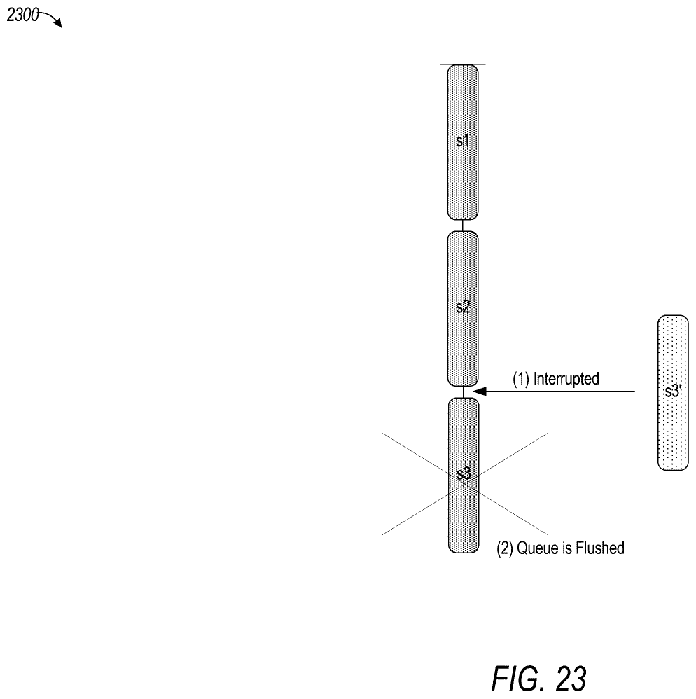

A successful interrupter can break the lineage of all downstream queued snapshots. Hence, when an interrupter is accepted, the downstream snapshots in the queue can be flushed out. This dramatically improves the useability as preemptively flushing invalid snapshots will avoid unnecessary pipe stalls. Consider the following example illustrated in FIG. 22 and FIG. 23.

FIG. 22 is a diagram 2200 of an Iceberg snapshot branching example, in accordance with some embodiments of the present disclosure.

FIG. 23 is a diagram 2300 of an accepted interrupter example where the interrupt is processed, and the downstream queue is flushed in an Iceberg table, in accordance with some embodiments of the present disclosure.

FIG. 22 and FIG. 23 illustrate an example of the interrupt and flush sequence of events. It can be crucial that the FPM flushes the queue after an interrupter is accepted because there can be reasonable confidence that the downstream snapshots will be invalid. In most practical scenarios, an interrupter will result in the pipe being stalled due to downstream snapshots failing lineage validation, and hence, AR will not succeed.

A slight deviation from this approach is to accept interrupts but not flush the queue. This can lead to interleaving, where a non-deterministic permutation of snapshots from various refresh executions races with each other to execute. This also will lead to high rates of pipe stalling, as successful interrupts will most likely break lineage, rendering AR unusable. While the FPM can enforce correctness with snapshot validation (to ensure illegal interrupters are rejected), this approach can result in inefficient behavior and also dramatically complicates debuggability.

In some aspects, the FPM can prevent interrupts by forwarding all attempting interrupters to enter our queue. This solution can be close to the semantics of manual refresh.

In some aspects, the FPM can treat all manual refresh invocations as a forwarding call to the source monitor, which guarantees the serial order of snapshot processing. This effectively acquires a file-level lock at the parent level, as in the manual refresh case, and completely blocks the risk of interleaving.

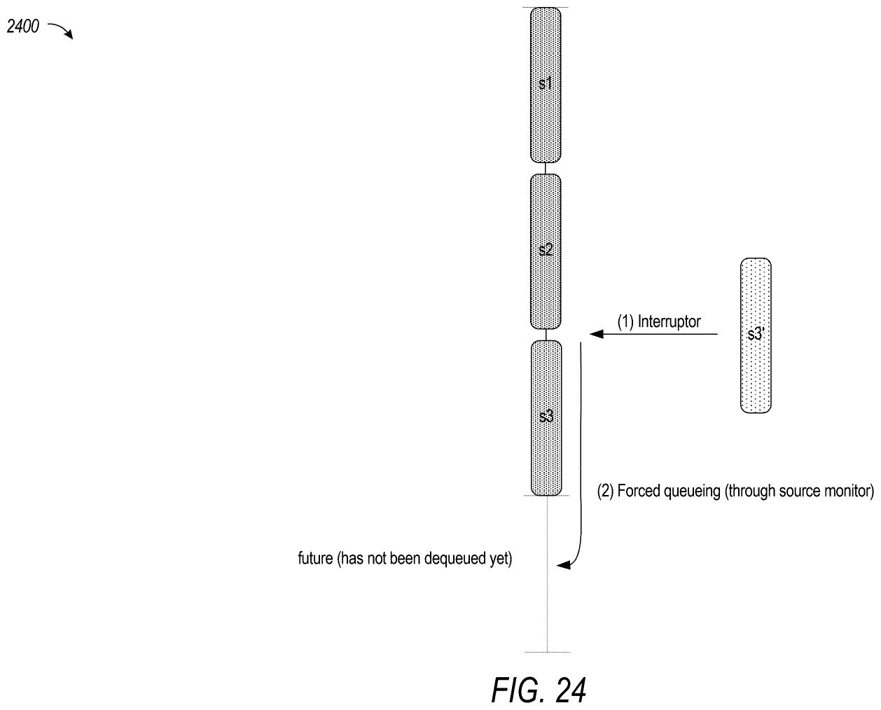

FIG. 24 is a diagram 2400 of an attempting interrupter example where the interrupt is prevented, and force queueing is performed to retain order in an Iceberg table, in accordance with some embodiments of the present disclosure.

Refreshing on an external catalog can result in external configuration errors. This can come at setup, between refresh executions, or during refresh execution. The FPM can handle each such scenario with the intent of saving computing resources.

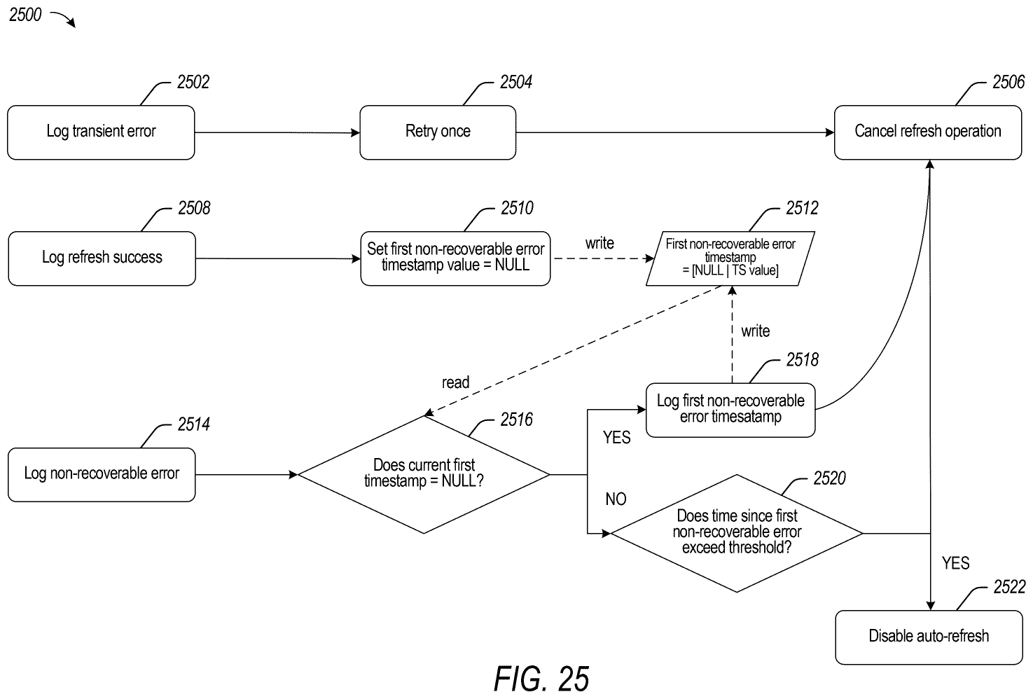

In some aspects, creating an Iceberg table with an external catalog necessitates that the catalog integration is functional. Whether it is a Glue catalog, object store, or any future integration, the creation of an Iceberg table can access the external resource to bootstrap the creation of the Iceberg table. With this assumption, the FPM can start polling the catalog using the source monitor. Any errors at table-creation time can be handled as a non-setup error since the FPM can perform setup validation for Iceberg table bootstrapping. FIG. 25 describes the error handling scenarios if encountered during catalog polling or refresh processing. The timestamp value logged can be a new slice on the processing pipeline data object (or PipeDPO).

FIG. 25 is a diagram of a logical flow 2500 for handling errors when polling the catalog and processing refresh operations for an Iceberg table, in accordance with some embodiments of the present disclosure. Logical flow 2500 includes operations 2502, 2504, 2506, 2508, 2510, 2512, 2514, 2516, 2518, 2520, and 2522, which are referenced in FIG. 25.

As illustrated in FIG. 25, all errors will terminate the refresh operation. Only non-recoverable errors can lead to disabling the auto-refresh for the table if a time threshold is reached. A similar mechanism can be employed using non-recoverable error counts rather than, or in addition to, a timestamp. A success in refreshing the table will reset metadata used to track disabling auto-refresh.

Examples of non-recoverable errors include permission denied, resource not found (catalog or table), and corrupted data or unprocessable data.

Examples of transient errors include service outages and rate limiting and throttling.

If a work item fails to be processed, the FPM will retry it in the containing pipeline step. If retries within the step fail, the FPM will requeue the work item and retry it from the beginning of the pipe.

Additional special handling of the above errors may need to be implemented for polling the external catalog and for processing Iceberg metadata and data. Any errors surfacing from remote storage calls should rely on a storage API to handle error categorization.

When auto-refresh is automatically disabled, a user might be able to “recover” by modifying settings and configurations via their cloud provider.

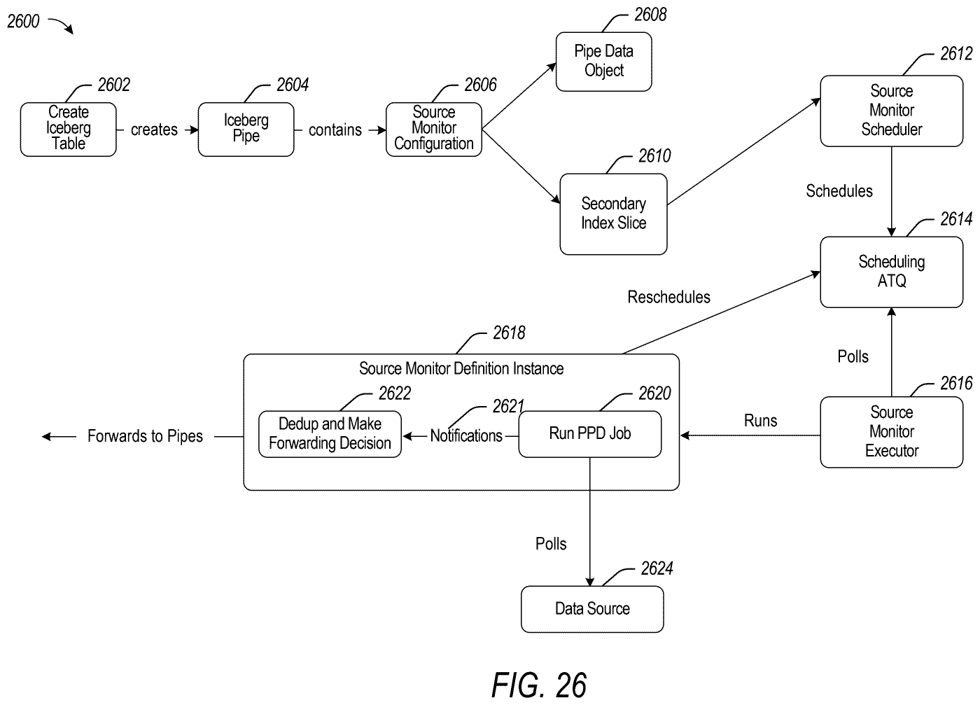

FIG. 26 is a diagram of a system 2600 for processing an Iceberg table using a source monitor definition instance, in accordance with some embodiments of the present disclosure. Referring to FIG. 26, system 2600 can be based on user-defined configurations, including an Iceberg table 2602 and Iceberg pipe configuration 2604. The Iceberg pipe configuration 2604 includes a source monitor configuration 2606, which can be persisted as a metadata object (e.g., as a pipe data object 2608) in a metadata store. The source monitor configuration 2606 is also persisted in a secondary index slice 2610 (e.g., for scheduling).

The FPM can activate a source monitor scheduler 2612, which schedules the instantiation of a source monitor via the scheduling ATQ 2614. A source monitor executor 2616 polls the scheduling ATQ 2614 and instantiates (e.g., runs) the source monitor definition instance 2618 as scheduled by the scheduling ATQ 2614. In some aspects, the source monitor definition instance 2618 is instantiated based on the source monitor configuration 2606 (which can be similar to the source monitor configuration 1002 of FIG. 10).

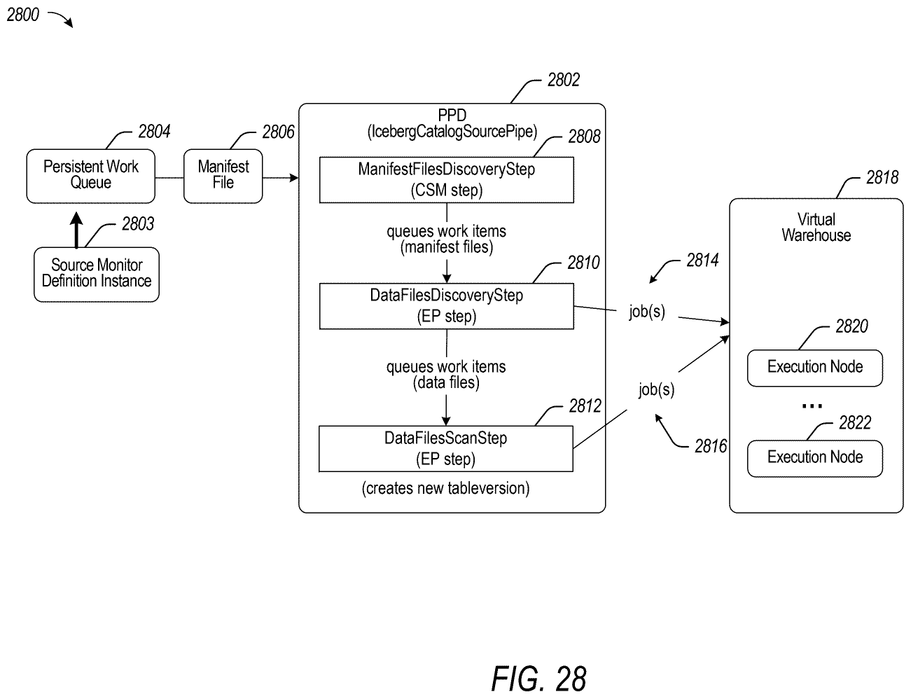

The source monitor definition instance 2618 can execute a PPD job at operation 2620 (e.g., based on executing one or more of the processing steps of the PPD associated with the source monitor definition) to obtain one or more notifications 2621 by polling the data source 2624. The source monitor definition instance 2618 can perform deduplication and forwarding decisions 2622 based on the one or more notifications 2621 (e.g., using the notification handler 912). The source monitor definition instance 2618 then forwards data associated with the one or more notifications 2621 to at least one work item queue associated with the Iceberg pipe configuration 2604 (e.g., persistent work queue 2804 of FIG. 28).

In some aspects, notifications 2621 returned by executing operation 2620 can implement the interface associated with the pseudo code listed in Table 6 below. In some aspects, the interface contains methods that can be used to deduplicate and schedule the notification as a work item.

TABLE 6

public interface SourceMonitorNotification {
/**
Notification id used to dedup notifications.
*/
public String getNotificationId( ) {
}
/**
Convert notification to pipe workItem.
*/
public WorkItem toWorkItem( ) {
}
}

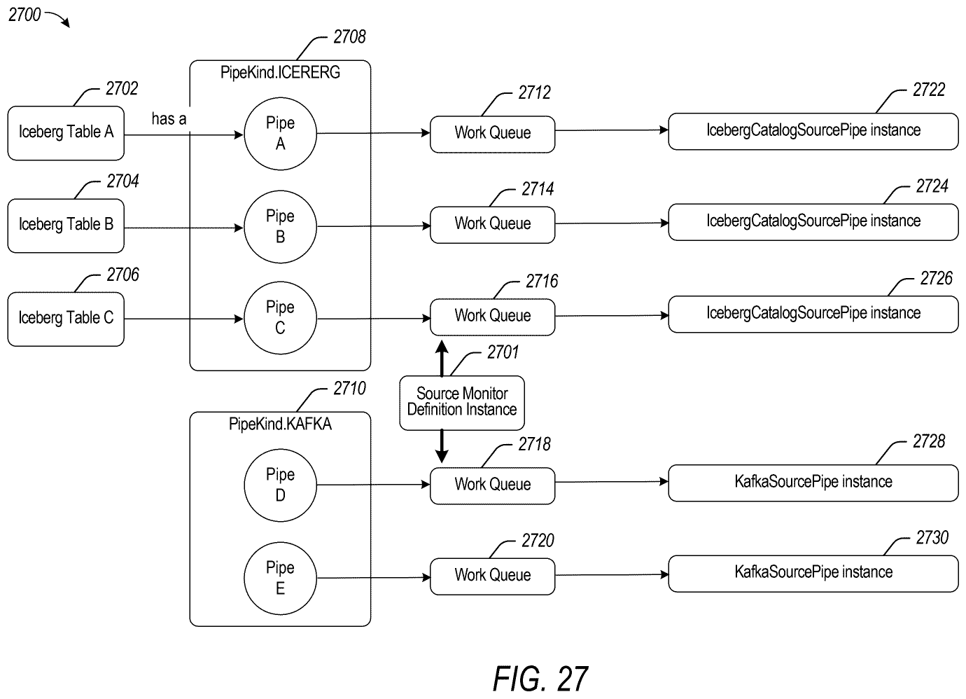

FIG. 27 is a block diagram 2700 of processing data by multiple PPD instances associated with different processing pipeline types, in accordance with some embodiments of the present disclosure. Referring to FIG. 27, workload data from Iceberg tables 2702, 2704, and 2706 is associated with processing pipeline type 2708 (e.g., Iceberg table type, also referred to as PipeKind.Iceberg). Iceberg data from Iceberg tables 2702, 2704, and 2706 is loaded in corresponding work queues 2712, 2714, and 2716. Corresponding PPD instances 2722, 2724, and 2726 are instantiated and used to process the Iceberg data from work queues 2712, 2714, and 2716.

Similarly, KAFKA-related data can be associated with processing pipeline type 2710 (e.g., KAFKA type, also referred to as PipeKind.KAFKA). KAFKA data is loaded in work queues 2718 and 2720. Corresponding PPD instances 2728 and 2730 are instantiated and used to process the KAFKA data from work queues 2718 and 2720.

In some aspects, a source monitor definition instance 2701 (which can be similar to source monitor definition instance 830 or source monitor definition instance 2618) can be configured to poll for new data and fetch such data into work queues 2712-2720.

FIG. 28 is a block diagram 2800 of a PPD 2802 used in connection with processing Apache Iceberg data, in accordance with some embodiments of the present disclosure. Referring to FIG. 28, source monitor definition instance 2803 monitors a data source (not illustrated in FIG. 28) and fetches any newly detected data into the persistent work queue 2804. When new (or updated) data is present in the persistent work queue 2804, such data is retrieved as a manifest file 2806.

PPD 2802 is generated based on one or more workloads specified by the manifest file 2806. More specifically, a first processing step 2808 can be configured as a CSM step to fetch work items from a pending queue (e.g., persistent work queue 2804) and enqueue the fetched items (e.g., manifest file 2806) for processing by the next step. In some aspects, the following pseudo code in Table 7 can be used to configure processing step 2808:

```
TABLE 7
Java
/** Step - 1 */
public class ManifestFilesDiscoveryStep implements CSMStep {
public ManifestFilesDiscoveryStep(CSM Step nextStep) {
super(StepType.CSM_MODE);
}
/** Process one metadata file at a time. For each metadata file, the snapshots are
listed, and a work item is queued for each snapshot.
*/
public void processWorkItems(List<WorkItem> workItems) {
/**
For the given snapshot, discover all the manifest files, a dedup is performed, and
the new manifest files are identified in the snapshot. The next step's inbox is
obtained, and all the manifest files are stored. The manifest files are saved in the
work item's scratch space (can be used during re-run to skip execution)
*/
  nextStep.queueWork(/** new work item */)
  }
}
```

In some aspects, PPD 2802 is configured with a second processing step 2810, which can be configured as an EP step. More specifically, the second processing step 2810 obtains work items from the first processing step, gets (or generates) a query plan for the obtained work items, and estimates required tasks based on the work items. The second processing step 2810 can also configure checkpoint progress and task completion configurations (e.g., what functionalities to perform at a given checkpoint and the completion of the processing jobs 2814 associated with the tasks of the work items specified in the second processing step). In some aspects, the following pseudo code in Table 8 can be used to configure the second processing step 2810:

TABLE 8

```
/** Step - 2 */
public class DataFilesDiscoveryStep implements EPStep {
  List<String> dataFilePaths;
  public DataFilesDiscoveryStep(File Processing System Step nextStep) {
    super(StepType.XP_MODE);
}
/**
* The compiled query plan will contain a single step, which will take
* a continuous scanset. Scanset will accept a list of manifest files
* and the data files can be discovered in EP.
*/
IProgramGenerator getProgramGenerator( ) {
// compile and return the query plan.
}
override List<WorkItem> getWorkItemBatch(int batchSize) {
// return “batchSize” number of items
}
/**
* Task estimation will be based on the number of manifest files.
* Discovery of data files in manifest files can happen in parallel.
*/
ITaskCountCalculator getTaskCountCalculator( ) {
// return task count based on the number of manifest files
}
void processStepProgress(StepProgressData progressData) {
/**
Write the data files that have been discovered on the work item's scratch
Space. Mark the manifest files that have been completed in the work item's
scratch space. In the case of a re-run, use the information to skip partial/full
execution.
*/
}
void processStepCompletion(StepCompletionData completionData) {
// Write an end marker and move the items in the work item's scratch space
// to the next step's inbox
// queue work items to the next step
nextStep.queueWork(/** new work items from dataFilesPath */)
}
}
```

In some aspects, PPD 2802 is configured with a third processing step 2812, which can be configured as an EP step. More specifically, the third processing step 2812 obtains work items from the second processing step. It generates or performs the following functions: determine/obtain a number of tasks/items in the query plan, compile the query plan, task estimation and task count generation based on the number of manifest files associated with the workload, and perform pre-configured functions/steps during execution of processing jobs 2816 or at completion time after processing jobs 2816 have been completed. In some aspects, the following pseudo code in Table 9 can be used to configure the third processing step 2812:

TABLE 9
/** Step - 3 */
public class DataFilesScanStep implements EPStep {
public DataFilesScanStep( ) {
super(StepType.XP_MODE);
}
override List<WorkItem> getWorkItemBatch(int batchSize) {
// return “batchSize” number of items
}
/**
* The compiled query plan will contain a single step, which will take
* a continuous scanset. Scanset will accept a list of manifest files
* and the data files are discovered in EP
*/
IProgramGenerator getProgramGenerator( ) {
// compile and return the query plan.
}
/**
* Task estimation will be based on the number of manifest files.
* Discovery of data files in manifest files can happen in parallel.
*/
ITaskCountCalculator getTaskCountCalculator( ) {
// return task count based on the number of manifest files
}
void processStepProgress(StepProgressData progressData) {
/**
Write the EP file info that has been written in the work item's scratch
Space. Mark the data files that have been completed in the work item's scratch
Space. In the case of a re-run, use the information to skip partial/full execution.
*/
}
void processStepCompletion(StepCompletionData completionData) {
/**
Write a new table version for all the EP files. Schedule cleanup of scratch spaces
and inbox for all steps. Finish work item and remove from queue.
*/
}
}

In some aspects, PPD 2802 can include configurations to specify one or more slots of at least one of execution nodes 2820, . . . , 2822 in virtual warehouse 2818 to perform processing jobs 2814 and 2816.

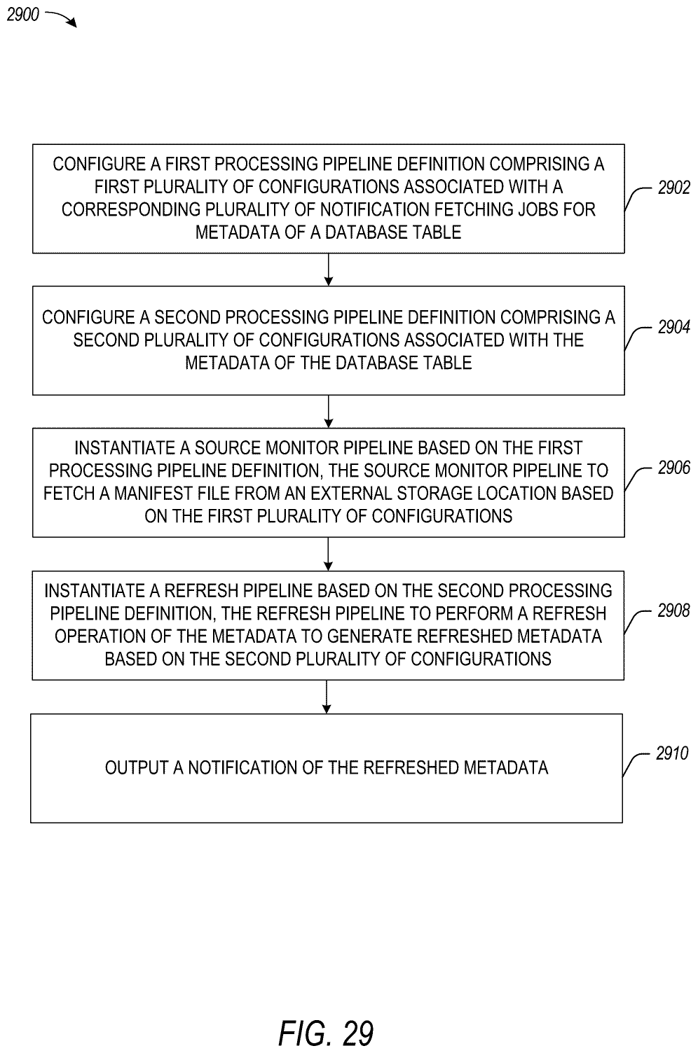

FIG. 29 is a flow diagram illustrating the operations of a database system in performing a method 2900 for configuring a source monitor, in accordance with some embodiments of the present disclosure. Method 2900 may be embodied in computer-readable instructions for execution by one or more hardware components (e.g., one or more processors) such that the operations of method 2900 may be performed by components of network-based database system 102, such as components of the execution platform 110 (e.g., the FPM 128) and/or the compute service manager 108 (which components may be implemented as machine 3000 of FIG. 30). Accordingly, method 2900 is described below, by way of example with reference thereto. However, it should be noted that method 2900 may be deployed on various other hardware configurations and is not intended to be limited to deployment within the network-based database system 102.

At operation 2902, the FPM 128 can configure a first processing pipeline definition. The first processing pipeline definition (e.g., source monitor definition 902) includes a first plurality of configurations (e.g., configurations of processing steps 908, . . . , 910) associated with a corresponding plurality of notification fetching jobs for metadata of a database table.

At operation 2904, FPM 128 configures a second processing pipeline definition (e.g., PPD 706 or PPD 2802). The second processing pipeline definition includes a second plurality of configurations associated with the metadata of the database table.

At operation 2906, FPM 128 instantiates a source monitor pipeline (e.g., source monitor pipeline 1402) based on the first processing pipeline definition. The source monitor pipeline fetches a manifest file of the database table from an external storage location based on the first plurality of configurations.

At operation 2908, FPM 128 instantiates a refresh pipeline (e.g., refresh pipeline 1406) based on the second processing pipeline definition. The refresh pipeline performs a refresh operation of the metadata to generate refreshed metadata based on the second plurality of configurations.

At operation 2910, FPM 128 outputs a notification of the refreshed metadata.

FIG. 30 illustrates a diagrammatic representation of machine 3000 in the form of a computer system within which a set of instructions may be executed to cause machine 3000 to perform any one or more of the methodologies discussed herein, according to an example embodiment. Specifically, FIG. 30 shows a diagrammatic representation of machine 3000 in the example form of a computer system, within which instructions 3016 (e.g., software, a program, an application, an applet, an app, or other executable code) for causing the machine 3000 to perform any one or more of the methodologies discussed herein may be executed. For example, instructions 3016 may cause machine 3000 to execute any one or more operations of method 2900 (or any other technique discussed herein, for example in connection with FIG. 4-FIG. 29). As another example, instructions 3016 may cause machine 3000 to implement one or more portions of the functionalities discussed herein. In this way, instructions 3016 may transform a general, non-programmed machine into a particular machine 3000 (e.g., the compute service manager 108 or a node in the execution platform 110) that is specially configured to carry out any one of the described and illustrated functions in the manner described herein. In yet another embodiment, instructions 3016 may configure the compute service manager 108 and/or a node in the execution platform 110 to carry out any one of the described and illustrated functions in the manner described herein.

In alternative embodiments, the machine 3000 operates as a standalone device or may be coupled (e.g., networked) to other machines. In a networked deployment, machine 3000 may operate in the capacity of a server machine or a client machine in a server-client network environment or as a peer machine in a peer-to-peer (or distributed) network environment. The machine 3000 may comprise, but not be limited to, a server computer, a client computer, a personal computer (PC), a tablet computer, a laptop computer, a netbook, a smartphone, a mobile device, a network router, a network switch, a network bridge, or any machine capable of executing the instructions 3016, sequentially or otherwise, that specify actions to be taken by the machine 3000. Further, while only a single machine 3000 is illustrated, the term “machine” shall also be taken to include a collection of machines 3000 that individually or jointly execute the instructions 3016 to perform any one or more of the methodologies discussed herein.

Machine 3000 includes processors 3010, memory 3030, and input/output (I/O) components 3050 configured to communicate with each other, such as via bus 3002. In some example embodiments, the processors 3010 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 3012 and a processor 3014 that may execute the instructions 3016. The term “processor” is intended to include multi-core processors 3010 that may comprise two or more independent processors (sometimes referred to as “cores”) that may execute instructions 3016 contemporaneously. Although FIG. 30 shows multiple processors 3010, machine 3000 may include a single processor with a single core, a single processor with multiple cores (e.g., a multi-core processor), multiple processors with a single core, multiple processors with multiple cores, or any combination thereof.

The memory 3030 may include a main memory 3032, a static memory 3034, and a storage unit 3036, all accessible to the processors 3010, such as via the bus 3002. The main memory 3032, the static memory 3034, and the storage unit 3036 store the instructions 3016, which embody any one or more of the methodologies or functions described herein. The instructions 3016 may also reside, wholly or partially, within the main memory 3032, within the static memory 3034, within machine storage medium 3038 of the storage unit 3036, within at least one of the processors 3010 (e.g., within the processor's cache memory), or any suitable combination thereof, during execution thereof by the machine 3000.

The I/O components 3050 include components to receive input, provide output, produce output, transmit information, exchange information, capture measurements, and so on. The specific I/O components 3050 that are included in a particular machine 3000 will depend on the type of machine. For example, portable machines such as mobile phones will likely include a touch input device or other such input mechanisms, while a headless server machine will likely not include such a touch input device. It would be appreciated that the I/O components 3050 may include many other components that are not shown in FIG. 30. The I/O components 3050 are grouped according to functionality merely to simplify the following discussion, and the grouping is in no way limiting. In various example embodiments, the I/O components 3050 may include output components 3052 and input components 3054. The output components 3052 may include visual components (e.g., a display such as a plasma display panel (PDP), a light-emitting diode (LED) display, a liquid crystal display (LCD), a projector, or a cathode ray tube (CRT)), acoustic components (e.g., speakers), other signal generators, and so forth. The input components 3054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures or other tactile input components), audio input components (e.g., a microphone), and the like.

Communication may be implemented using a wide variety of technologies. The I/O components 3050 may include communication components 3064, operable to couple the machine 3000 to a network 3080 or devices 3070 via a coupling 3082 and a coupling 3072, respectively. For example, the communication components 3064 may include a network interface component or another suitable device to interface with network 3080. In further examples, communication components 3064 may include wired communication components, wireless communication components, cellular communication components, and other communication components to provide communication via other modalities. The device 3070 may be another machine or any of a wide variety of peripheral devices (e.g., a peripheral device coupled via a universal serial bus (USB)). For example, as noted above, machine 3000 may correspond to any one of the compute service manager 108 or the execution platform 110, and device 3070 may include the client device 114 or any other computing device described herein as being in communication with the network-based database system 102 or the cloud storage platform 104.

The various memories (e.g., 3030, 3032, 3034, and/or memory of the processor(s) 3010 and/or the storage unit 3036) may store one or more sets of instructions 3016 and data structures (e.g., software) embodying or utilized by any one or more of the methodologies or functions described herein. These instructions 3016, when executed by the processor(s) 3010, cause various operations to implement the disclosed embodiments.

As used herein, the terms “machine-storage medium,” “device-storage medium,” and “computer-storage medium” mean the same thing and may be used interchangeably in this disclosure. The terms refer to single or multiple storage devices and/or media (e.g., a centralized or distributed database and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example, semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 3080 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, network 3080 or a portion of network 3080 may include a wireless or cellular network, and the coupling 3082 may be a Code Division Multiple Access (CDMA) connection, a Global System for Mobile communications (GSM) connection, or another cellular or wireless coupling. In this example, the coupling 3082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 3016 may be transmitted or received over network 3080 using a transmission medium via a network interface device (e.g., a network interface component included in the communication components 3064) and utilizing any one of several well-known transfer protocols (e.g., hypertext transfer protocol (HTTP)). Similarly, instructions 3016 may be transmitted or received using a transmission medium via coupling 3072 (e.g., a peer-to-peer coupling) to device 3070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 3016 for execution by machine 3000, and include digital or analog communications signals or other intangible media to facilitate communication of such software. Hence, the terms “transmission medium” and “signal medium” shall be taken to include any form of a modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some example embodiments, the processor or processors may be located in a single location (e.g., within a home environment, an office environment, or a server farm), while in other embodiments, the processors may be distributed across several locations.

Described implementations of the subject matter can include one or more features, alone or in combination, as illustrated below by way of examples.
Example 1 is a system comprising: at least one hardware processor; and at least one memory storing instructions that cause the at least one hardware processor to perform operations comprising: configuring a first processing pipeline definition, the first processing pipeline definition comprising a first plurality of configurations associated with a corresponding plurality of notification fetching jobs for metadata of a database table; configuring a second processing pipeline definition, the second processing pipeline definition comprising a second plurality of configurations associated with the metadata of the database table; instantiating a source monitor pipeline based on the first processing pipeline definition, the source monitor pipeline to fetch a manifest file of the database table from an external storage location based on the first plurality of configurations; instantiating a refresh pipeline based on the second processing pipeline definition, the refresh pipeline to perform a refresh operation of the metadata to generate refreshed metadata based on the second plurality of configurations; and outputting a notification of the refreshed metadata.
In Example 2, the subject matter of Example 1 includes functionalities such as configuring the first plurality of configurations as a plurality of processing steps in the first processing pipeline definition and configuring the second plurality of configurations as a plurality of processing steps in the second processing pipeline definition.
In Example 3, the subject matter of Example 2 includes functionalities such as accessing scheduling information associated with at least one notification fetching job of the plurality of notification fetching jobs.
In Example 4, the subject matter of Example 3 includes functionalities such as scheduling execution of at least one of the plurality of processing steps in the source monitor pipeline to perform at least one of the plurality of notification fetching jobs based on the scheduling information.
In Example 5, the subject matter of Example 4 includes functionalities such as reading a plurality of metadata files of the database table to obtain a plurality of snapshots and forwarding the plurality of snapshots as a notification to a notification handler of the source monitor pipeline.
In Example 6, the subject matter of Example 5 includes functionalities such as filtering by the notification handler, the plurality of snapshots to generate at least one filtered snapshot; and forwarding a metadata file corresponding to the at least one filtered snapshot as the metadata of the database table to the refresh pipeline.
In Example 7, the subject matter of Examples 2-6 includes functionalities such as performing at the refresh pipeline, a first processing step of the plurality of processing steps in the second processing pipeline definition, and performing the first processing step comprising processing a metadata file of the metadata to determine a snapshot; obtaining locations of manifest files corresponding to the snapshot; and enqueuing the locations of the manifest files as inputs to a second processing step of the plurality of processing steps in the second processing pipeline definition.
In Example 8, the subject matter of Example 7 includes functionalities such as performing at the refresh pipeline, the second processing step of the plurality of processing steps in the second processing pipeline definition, and performing the second processing step comprising accessing the manifest files based on the locations of the manifest files; determining data file locations based on the manifest files; generating inventory files based on data files stored at the data file locations; and enqueuing locations of the inventory files as inputs to a third processing step of the plurality of processing steps in the second processing pipeline definition.
In Example 9, the subject matter of Example 8 includes functionalities such as performing at the refresh pipeline, the third processing step of the plurality of processing steps in the second processing pipeline definition, and performing the third processing step comprising parsing the inventory files to detect a deletion operation or a deregistration operation; updating the inventory files based on the detected deletion operation or deregistration operation to obtain updated inventory files; and forwarding locations of the updated inventory files as inputs to a fourth processing step of the plurality of processing steps in the second processing pipeline definition.
In Example 10, the subject matter of Example 9 includes functionalities such as performing at the refresh pipeline, the fourth processing step of the plurality of processing steps in the second processing pipeline definition, and performing the fourth processing step comprising translating the updated inventory files into the refreshed metadata; and registering the refreshed metadata to the database table.
Example 11 is a method comprising: configuring, by at least one hardware processor, a first processing pipeline definition, the first processing pipeline definition comprising a first plurality of configurations associated with a corresponding plurality of notification fetching jobs for metadata of a database table; configuring a second processing pipeline definition, the second processing pipeline definition comprising a second plurality of configurations associated with the metadata of the database table; instantiating a source monitor pipeline based on the first processing pipeline definition, the source monitor pipeline to fetch a manifest file of the database table from an external storage location based on the first plurality of configurations; instantiating a refresh pipeline based on the second processing pipeline definition, the refresh pipeline to perform a refresh operation of the metadata to generate refreshed metadata based on the second plurality of configurations; and outputting a notification of the refreshed metadata.
In Example 12, the subject matter of Example 11 includes configuring the first plurality of configurations as a plurality of processing steps in the first processing pipeline definition and configuring the second plurality of configurations as a plurality of processing steps in the second processing pipeline definition.
In Example 13, the subject matter of Example 12 includes accessing scheduling information associated with at least one notification fetching job of the plurality of notification fetching jobs.
In Example 14, the subject matter of Example 13 includes scheduling execution of at least one of the plurality of processing steps in the source monitor pipeline to perform at least one of the plurality of notification fetching jobs based on the scheduling information.
In Example 15, the subject matter of Example 14 includes reading a plurality of metadata files of the database table to obtain a plurality of snapshots and forwarding the plurality of snapshots as a notification to a notification handler of the source monitor pipeline.
In Example 16, the subject matter of Example 15 includes filtering by the notification handler, the plurality of snapshots to generate at least one filtered snapshot; and forwarding a metadata file corresponding to the at least one filtered snapshot as the metadata of the database table to the refresh pipeline.
In Example 17, the subject matter of Examples 12-16 includes performing at the refresh pipeline, a first processing step of the plurality of processing steps in the second processing pipeline definition, and performing the first processing step comprising processing a metadata file of the metadata to determine a snapshot; obtaining locations of manifest files corresponding to the snapshot; and enqueuing the locations of the manifest files as inputs to a second processing step of the plurality of processing steps in the second processing pipeline definition.
In Example 18, the subject matter of Example 17 includes performing at the refresh pipeline, the second processing step of the plurality of processing steps in the second processing pipeline definition, and performing the second processing step comprising accessing the manifest files based on the locations of the manifest files; determining data file locations based on the manifest files; generating inventory files based on data files stored at the data file locations; and enqueuing locations of the inventory files as inputs to a third processing step of the plurality of processing steps in the second processing pipeline definition.
In Example 19, the subject matter of Example 18 includes performing at the refresh pipeline, the third processing step of the plurality of processing steps in the second processing pipeline definition, and performing the third processing step comprising parsing the inventory files to detect a deletion operation or a deregistration operation; updating the inventory files based on the detected deletion operation or deregistration operation to obtain updated inventory files; and forwarding locations of the updated inventory files as inputs to a fourth processing step of the plurality of processing steps in the second processing pipeline definition.
In Example 20, the subject matter of Example 19 includes performing at the refresh pipeline, the fourth processing step of the plurality of processing steps in the second processing pipeline definition, and performing the fourth processing step comprising translating the updated inventory files into the refreshed metadata; and registering the refreshed metadata to the database table.
Example 21 is a computer-storage medium comprising instructions that, when executed by one or more processors of a machine, configure the machine to perform operations comprising: configuring a first processing pipeline definition, the first processing pipeline definition comprising a first plurality of configurations associated with a corresponding plurality of notification fetching jobs for metadata of a database table; configuring a second processing pipeline definition, the second processing pipeline definition comprising a second plurality of configurations associated with the metadata of the database table; instantiating a source monitor pipeline based on the first processing pipeline definition, the source monitor pipeline to fetch a manifest file of the database table from an external storage location based on the first plurality of configurations; instantiating a refresh pipeline based on the second processing pipeline definition, the refresh pipeline to perform a refresh operation of the metadata to generate refreshed metadata based on the second plurality of configurations; and outputting a notification of the refreshed metadata.
In Example 22, the subject matter of Example 21 includes functionalities such as configuring the first plurality of configurations as a plurality of processing steps in the first processing pipeline definition and configuring the second plurality of configurations as a plurality of processing steps in the second processing pipeline definition.
In Example 23, the subject matter of Example 22 includes functionalities such as accessing scheduling information associated with at least one notification fetching job of the plurality of notification fetching jobs.
In Example 24, the subject matter of Example 23 includes functionalities such as scheduling execution of at least one of the plurality of processing steps in the source monitor pipeline to perform at least one of the plurality of notification fetching jobs based on the scheduling information.
In Example 25, the subject matter of Example 24 includes functionalities such as reading a plurality of metadata files of the database table to obtain a plurality of snapshots and forwarding the plurality of snapshots as a notification to a notification handler of the source monitor pipeline.
In Example 26, the subject matter of Example 25 includes functionalities such as filtering by the notification handler, the plurality of snapshots to generate at least one filtered snapshot; and forwarding a metadata file corresponding to the at least one filtered snapshot as the metadata of the database table to the refresh pipeline.
In Example 27, the subject matter of Examples 22-26 includes functionalities such as performing at the refresh pipeline, a first processing step of the plurality of processing steps in the second processing pipeline definition, and performing the first processing step comprising processing a metadata file of the metadata to determine a snapshot; obtaining locations of manifest files corresponding to the snapshot; and enqueuing the locations of the manifest files as inputs to a second processing step of the plurality of processing steps in the second processing pipeline definition.
In Example 28, the subject matter of Example 27 includes functionalities such as performing at the refresh pipeline, the second processing step of the plurality of processing steps in the second processing pipeline definition, and performing the second processing step comprising accessing the manifest files based on the locations of the manifest files; determining data file locations based on the manifest files; generating inventory files based on data files stored at the data file locations; and enqueuing locations of the inventory files as inputs to a third processing step of the plurality of processing steps in the second processing pipeline definition.
In Example 29, the subject matter of Example 28 includes functionalities such as performing at the refresh pipeline, the third processing step of the plurality of processing steps in the second processing pipeline definition, and performing the third processing step comprising parsing the inventory files to detect a deletion operation or a deregistration operation; updating the inventory files based on the detected deletion operation or deregistration operation to obtain updated inventory files; and forwarding locations of the updated inventory files as inputs to a fourth processing step of the plurality of processing steps in the second processing pipeline definition.
In Example 30, the subject matter of Example 29 includes functionalities such as performing at the refresh pipeline, the fourth processing step of the plurality of processing steps in the second processing pipeline definition, and performing the fourth processing step comprising translating the updated inventory files into the refreshed metadata; and registering the refreshed metadata to the database table.
Example 31 is at least one machine-readable medium including instructions that, when executed by processing circuitry, cause the processing circuitry to perform operations to implement any of Examples 1-30.
Example 32 is an apparatus comprising means to implement any of Examples 1-30.
Example 33 is a system to implement any of Examples 1-30.
Example 34 is a method to implement any of Examples 1-30.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various embodiments. Combinations of the above embodiments and other embodiments not explicitly described herein will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to perform operations comprising:
configuring a first processing pipeline definition, the first processing pipeline definition comprising a first plurality of configurations associated with a corresponding plurality of notification fetching jobs for metadata of a database table;
configuring a second processing pipeline definition, the second processing pipeline definition comprising a second plurality of configurations associated with the metadata of the database table;
instantiating a source monitor pipeline based on the first processing pipeline definition, the source monitor pipeline to fetch a manifest file of the database table from an external storage location based on the first plurality of configurations;
instantiating a refresh pipeline based on the second processing pipeline definition, the refresh pipeline to perform a refresh operation of the metadata to generate refreshed metadata based on the second plurality of configurations; and
outputting a notification of the refreshed metadata.

2. The system of claim 1, the operations comprising:
configuring the first plurality of configurations as a plurality of processing steps in the first processing pipeline definition; and
configuring the second plurality of configurations as a plurality of processing steps in the second processing pipeline definition.

3. The system of claim 2, the operations comprising:
accessing scheduling information associated with at least one notification fetching job of the plurality of notification fetching jobs.

4. The system of claim 3, the operations comprising:
scheduling execution of at least one of the plurality of processing steps in the source monitor pipeline to perform at least one of the plurality of notification fetching jobs based on the scheduling information.

5. The system of claim 4, the operations comprising:
reading a plurality of metadata files of the database table to obtain a plurality of snapshots; and
forwarding the plurality of snapshots as a notification to a notification handler of the source monitor pipeline.

6. The system of claim 5, the operations comprising:
filtering by the notification handler, the plurality of snapshots to generate at least one filtered snapshot; and
forwarding a metadata file corresponding to the at least one filtered snapshot as the metadata of the database table to the refresh pipeline.

7. The system of claim 2, the operations comprising:
performing at the refresh pipeline, a first processing step of the plurality of processing steps in the second processing pipeline definition, and performing the first processing step comprising:
processing a metadata file of the metadata to determine a snapshot;
obtaining locations of manifest files corresponding to the snapshot; and
enqueuing the locations of the manifest files as inputs to a second processing step of the plurality of processing steps in the second processing pipeline definition.

8. The system of claim 7, the operations comprising:
performing at the refresh pipeline, the second processing step of the plurality of processing steps in the second processing pipeline definition, and performing the second processing step comprising:
accessing the manifest files based on the locations of the manifest files;
determining data file locations based on the manifest files;
generating inventory files based on data files stored at the data file locations; and
enqueuing locations of the inventory files as inputs to a third processing step of the plurality of processing steps in the second processing pipeline definition.

9. The system of claim 8, the operations comprising:
performing at the refresh pipeline, the third processing step of the plurality of processing steps in the second processing pipeline definition, and performing the third processing step comprising:
parsing the inventory files to detect a deletion operation or a deregistration operation;
updating the inventory files based on the detected deletion operation or deregistration operation to obtain updated inventory files; and
forwarding locations of the updated inventory files as inputs to a fourth processing step of the plurality of processing steps in the second processing pipeline definition.

10. The system of claim 9, the operations comprising:
performing at the refresh pipeline, the fourth processing step of the plurality of processing steps in the second processing pipeline definition, and performing the fourth processing step comprising:
translating the updated inventory files into the refreshed metadata; and
registering the refreshed metadata to the database table.

11. A method comprising:
configuring, by at least one hardware processor, a first processing pipeline definition, the first processing pipeline definition comprising a first plurality of configurations associated with a corresponding plurality of notification fetching jobs for metadata of a database table;
configuring a second processing pipeline definition, the second processing pipeline definition comprising a second plurality of configurations associated with the metadata of the database table;
instantiating a source monitor pipeline based on the first processing pipeline definition, the source monitor pipeline to fetch a manifest file of the database table from an external storage location based on the first plurality of configurations;
instantiating a refresh pipeline based on the second processing pipeline definition, the refresh pipeline to perform a refresh operation of the metadata to generate refreshed metadata based on the second plurality of configurations; and
outputting a notification of the refreshed metadata.

12. The method of claim 11, comprising:
configuring the first plurality of configurations as a plurality of processing steps in the first processing pipeline definition; and
configuring the second plurality of configurations as a plurality of processing steps in the second processing pipeline definition.

13. The method of claim 12, comprising:
accessing scheduling information associated with at least one notification fetching job of the plurality of notification fetching jobs.

14. The method of claim 13, further comprising:
scheduling execution of at least one of the plurality of processing steps in the source monitor pipeline to perform at least one of the plurality of notification fetching jobs based on the scheduling information.

15. The method of claim 14, comprising:
reading a plurality of metadata files of the database table to obtain a plurality of snapshots; and
forwarding the plurality of snapshots as a notification to a notification handler of the source monitor pipeline.

16. The method of claim 15, comprising:
filtering by the notification handler, the plurality of snapshots to generate at least one filtered snapshot; and
forwarding a metadata file corresponding to the at least one filtered snapshot as the metadata of the database table to the refresh pipeline.

17. The method of claim 12, comprising:
performing at the refresh pipeline, a first processing step of the plurality of processing steps in the second processing pipeline definition, and performing the first processing step comprising:
processing a metadata file of the metadata to determine a snapshot;
obtaining locations of manifest files corresponding to the snapshot; and
enqueuing the locations of the manifest files as inputs to a second processing step of the plurality of processing steps in the second processing pipeline definition.

18. The method of claim 17, comprising:
performing at the refresh pipeline, the second processing step of the plurality of processing steps in the second processing pipeline definition, and performing the second processing step comprising:
accessing the manifest files based on the locations of the manifest files;
determining data file locations based on the manifest files;
generating inventory files based on data files stored at the data file locations; and
enqueuing locations of the inventory files as inputs to a third processing step of the plurality of processing steps in the second processing pipeline definition.

19. The method of claim 18, comprising:
performing at the refresh pipeline, the third processing step of the plurality of processing steps in the second processing pipeline definition, and performing the third processing step comprising:
parsing the inventory files to detect a deletion operation or a deregistration operation;
updating the inventory files based on the detected deletion operation or deregistration operation to obtain updated inventory files; and
forwarding locations of the updated inventory files as inputs to a fourth processing step of the plurality of processing steps in the second processing pipeline definition.

20. The method of claim 19, comprising:
performing at the refresh pipeline, the fourth processing step of the plurality of processing steps in the second processing pipeline definition, and performing the fourth processing step comprising:
translating the updated inventory files into the refreshed metadata; and
registering the refreshed metadata to the database table.

21. A computer-storage medium comprising instructions that, when executed by one or more processors of a machine, configure the machine to perform operations comprising:
configuring a first processing pipeline definition, the first processing pipeline definition comprising a first plurality of configurations associated with a corresponding plurality of notification fetching jobs for metadata of a database table;
configuring a second processing pipeline definition, the second processing pipeline definition comprising a second plurality of configurations associated with the metadata of the database table;
instantiating a source monitor pipeline based on the first processing pipeline definition, the source monitor pipeline to fetch a manifest file of the database table from an external storage location based on the first plurality of configurations;
instantiating a refresh pipeline based on the second processing pipeline definition, the refresh pipeline to perform a refresh operation of the metadata to generate refreshed metadata based on the second plurality of configurations; and
outputting a notification of the refreshed metadata.

22. The computer-storage medium of claim 21, the operations comprising:
configuring the first plurality of configurations as a plurality of processing steps in the first processing pipeline definition; and
configuring the second plurality of configurations as a plurality of processing steps in the second processing pipeline definition.

23. The computer-storage medium of claim 22, the operations comprising:
accessing scheduling information associated with at least one notification fetching job of the plurality of notification fetching jobs.

24. The computer-storage medium of claim 23, the operations comprising:
scheduling execution of at least one of the plurality of processing steps in the source monitor pipeline to perform at least one of the plurality of notification fetching jobs based on the scheduling information.

25. The computer-storage medium of claim 24, the operations comprising:
reading a plurality of metadata files of the database table to obtain a plurality of snapshots; and
forwarding the plurality of snapshots as a notification to a notification handler of the source monitor pipeline.

26. The computer-storage medium of claim 25, the operations comprising:
filtering by the notification handler, the plurality of snapshots to generate at least one filtered snapshot; and
forwarding a metadata file corresponding to the at least one filtered snapshot as the metadata of the database table to the refresh pipeline.

27. The computer-storage medium of claim 22, the operations comprising:
performing at the refresh pipeline, a first processing step of the plurality of processing steps in the second processing pipeline definition, and performing the first processing step comprising:
processing a metadata file of the metadata to determine a snapshot;
obtaining locations of manifest files corresponding to the snapshot; and
enqueuing the locations of the manifest files as inputs to a second processing step of the plurality of processing steps in the second processing pipeline definition.

28. The computer-storage medium of claim 27, the operations comprising:
performing at the refresh pipeline, the second processing step of the plurality of processing steps in the second processing pipeline definition, and performing the second processing step comprising:
accessing the manifest files based on the locations of the manifest files;
determining data file locations based on the manifest files;
generating inventory files based on data files stored at the data file locations; and
enqueuing locations of the inventory files as inputs to a third processing step of the plurality of processing steps in the second processing pipeline definition.

29. The computer-storage medium of claim 28, the operations comprising:
performing at the refresh pipeline, the third processing step of the plurality of processing steps in the second processing pipeline definition, and performing the third processing step comprising:
parsing the inventory files to detect a deletion operation or a deregistration operation;
updating the inventory files based on the detected deletion operation or deregistration operation to obtain updated inventory files; and
forwarding locations of the updated inventory files as inputs to a fourth processing step of the plurality of processing steps in the second processing pipeline definition.

30. The computer-storage medium of claim 29, the operations comprising:
performing at the refresh pipeline, the fourth processing step of the plurality of processing steps in the second processing pipeline definition, and performing the fourth processing step comprising:
translating the updated inventory files into the refreshed metadata; and
registering the refreshed metadata to the database table.
